(19) United States
(12) Patent Application Publication
(10) Pub. No.: US 2024/0260144 A1
(43) Pub. Date: Aug. 1, 2024

(54) STABLE THIN FILM HEATERS BASED ON TRANSPARENT CONDUCTIVE COATINGS, STRUCTURES FORMED WITH THE HEATERS AND APPLICATIONS THEREOF

(71) Applicant: C3 Nano, Inc., Hayward, CA (US)

(72) Inventors: Xiaofeng Chen, San Jose, CA (US); Michael Fang, Hayward, CA (US); Yadong Cao, San Jose, CA (US); Alexander Seung-il Hong, San Mateo, CA (US); Xiqiang Yang, Hayward, CA (US); Ajay Virkar, San Mateo, CA (US); Devika Madan Oak, Dublin, CA (US); Feiqun Li, Guangdong (CN); Qiuxiang Zhang, Jiangsu (CN)

(21) Appl. No.: 18/422,462

(22) Filed: Jan. 25, 2024

Related U.S. Application Data
(60) Provisional application No. 63/441,656, filed on Jan. 27, 2023.

(30) Foreign Application Priority Data
Oct. 18, 2023 (CN) 202311352632.X

(51) Int. Cl. H05B 3/84; H01C 1/16; G01J 5/00

(52) U.S. Cl. CPC H05B 3/84; H01C 1/16; G01J 2005/0077; G01J 5/0096; H05B 2203/013; H05B 2214/04

(57) ABSTRACT

A transparent structure comprising a transparent substrate, a transparent resistive heating element mounted on the substrate, metal traces forming electrodes arranged to be in electrical contact with the transparent heating element and positioned around boundaries of a heated region defining a circuit for electrical flow through the transparent resistive heating element, and a power source connected to the electrodes with the capability of delivering at least 1 volts to the electrodes wherein the transparent resistive heating element comprises a sparse metal conductive layer comprising nanowire segments of noble metal coated silver having a sheet resistance from about 1 Ohms/sq. to about 300 Ohms/sq and having an unpatterned area of at least about 0.25 cm².

### CROSS REFERENCE TO RELATED APPLICATIONS

This application claims priority to U.S. Provisional Patent Application No. 63/441,656, filed Jan. 27, 2023 to Chen et al., entitled “Stable Thin Film Heaters Based on Noble Metal Coated Silver Nanowires and Applications Thereof,” and Chinese patent application 202311352632.X, filed Oct. 18, 2023 to Chen et al., entitled “Stable Thin Film Heaters Based on Transparent Conductive Coatings, Structures Formed With the Heaters and Applications Thereof, both of which are incorporated herein by reference.

### FIELD OF THE INVENTION

The invention relates to thin film heaters that can be effective to heat surfaces for transparent structures. The invention further relates to methods for applying thin film heaters to various surfaces, including but not limited to forming the heating element on a flexible polymer film for lamination to the surface to be heated. The invention also relates to heater construction in the context of different heater shapes.

### BACKGROUND OF THE INVENTION

Various circumstances suggest a desire to have a heated surface. In some circumstances, the surfaces are transparent, so heating can be used to help clear ice, snow or moisture generally from the surface to improve visualization. For example, windows for cars and other vehicles, such as trucks, airplanes, and the like, can have window heaters. With growing use of machine vision, useful wavelengths for visualization can extend from the visible wavelengths into the infrared. Self-driving vehicles are generally reliant on transmission and reception of electromagnetic radiation to provide for construction of an image to guide movement.

### SUMMARY OF THE INVENTION

In a first aspect, the invention pertains to a heater structure comprising a transparent substrate, a transparent resistive heating element mounted on the substrate, metal traces forming electrodes arranged to be in electrical contact with the transparent resistive heating element and positioned along boundaries of a heated region defining a circuit for electrical flow through the transparent resistive heating element thereby forming the heated region, and a power source connected to the electrodes to the electrodes wherein the transparent resistive heating element comprises a sparse metal conductive layer comprising nanowire segments and having a sheet resistance from about 0.5 Ohms/sq. to about 300 Ohms/sq. In some embodiments, the power source can deliver at least one volt to the electrodes. A window for a vehicle can comprise the transparent heater structure as described above. An infrared based imaging system can comprise the transparent heater structure as described above.

In a further aspect, the invention pertains to a method for heating the surface of a structure, the method comprising delivering a voltage of at least 1 volts to a heating element to generate a surface power density of at least about 0.05 W/cm² for at least about 30 seconds, wherein the heating element comprises a transparent conductive film comprising segments of nanowires in a sparse metal conductive layer and having a sheet resistance from about 0.5 Ohms/sq to about 300 Ohms/sq.

In another aspect, the invention pertains to a method for making a transparent conductive heater on a surface, the method comprising 1) forming a coating of metal nanowires from a solution, 2) drying the nanowire coating to form a transparent conductive film, and 3) forming conductive electrodes establishing electrical connections to the transparent conductive film with a circuit path along the transparent conductive film between two electrodes forming a heater surface with significant surface power density generated across the heater surface from an applied voltage between the electrodes.

In other aspects, the invention pertains to a vehicle comprising a visualization device with a surface exposed to the ambient environment wherein the visualization device transmits and/or receives infrared light over a particular range with wavelengths from 750 nm to 3 microns, a transparent resistive heating element interfaced with the surface of the visualization device, and a control element. The transparent resistive heating element can comprise a sparse metal conductive layer comprising nanowire segments having a sheet resistance from about 1 Ohms/sq to about 300 Ohms/sq and having a transmittance of infrared light over the particular range of at least about 70%.

Moreover, the invention pertains to a heater structure having a transparent non-rectangular heater surface and comprising an electrically conductive element, wherein the electrically conductive element is non-uniform in resistance and is between one or more pairs of electrodes such that the power dissipation over the surface of the heater is more uniform relative to the power dissipation in an equivalent structure with a uniform transparent conductive coating.

In addition, the invention pertains to a heater structure comprising a transparent conductive layer, electrodes connected to a voltage source, and a polymer overcoat over at least a portion of the transparent conductive layer, wherein the transparent conductive coating provides electrical conduction between electrodes to provide heating and wherein the polymer overcoat comprises nanoparticles that provide improved thermal conductivity.

In further aspects, the invention pertains to a method for making a transparent conductive heater on a non-planer surface, the method comprising: mounting a flexible polymer substrate with a nanowire based transparent conductive heater surface onto a non-planar transparent surface. In some embodiments, the heater surface is oriented toward the transparent non-planar surface. In some embodiment, the resulting structure is a heated transparent structure.

### BRIEF DESCRIPTION OF THE DRAWINGS

FIG. 1 is a plot of transmittance as a function of wavelength for transparent silver nanowire-based films formed with a sheet resistance of 30-50 Ohms/sq on either a polyethylene terephthalate optical film or a polycarbonate optical film.

FIG. 2A shows a top view of a general layout of a heater with transparent nanowire based heating element supporting bus bars and controls.

FIG. 2B is a schematic top down view of a trapezoid shaped heater with a conductive layer between nonparallel metal traces showing effects of nonuniform distribution of electrical current.

FIG. 2C is a schematic top down view of a portion of a heater showing segmented metal traces, each electrically configured to be driven at the same or different voltages V₁-V₃.

FIG. 2D is a schematic top down view of a heater divided into segments, each heater segment electrically configured with a set of metal traces and a resistor for modifying current through to the corresponding heater segment.

FIG. 3A is a schematic top down view of a trapezoid shaped heater with a conductive layer between nonparallel metal traces with conceptual horizontal lines extending across the conductive layer dividing the layer into zones.

FIG. 3B is a schematic top down view of the trapezoid shaped heater shown in FIG. 3A with etched spots distributed across the conductive layer.

FIG. 4 is a schematic illustration of a windshield configured with a transparent heater.

FIGS. 5A and 5B are schematic cross-sectional views of transparent heaters with additional layers or substrates.

FIG. 6 shows a top view of the trace design used to evaluate the heating performance of transparent heater elements prepared with platinum coated and uncoated silver nanowires.

FIG. 7A is a plot of the change in temperature as a function of power density for heater elements prepared with platinum coated and uncoated silver nanowires and configured for heating using the trace design shown in FIG. 6.

FIG. 7B is a plot of the change in temperature as a function of voltage for heater elements prepared with platinum coated and uncoated silver nanowires and configured for heating using the trace design shown in FIG. 6.

FIGS. 8A and 8B show top views of trace designs used to evaluate the heating performance of transparent heater elements prepared with platinum coated silver nanowires.

FIGS. 9A-9C are plots of the change in temperature as a function of power density for heater elements prepared with platinum coated silver nanowires and configured for heating using the trace designs shown in FIGS. 8A and 8B.

FIGS. 10A-10C show thermal images of heater elements prepared with platinum coated silver nanowires and configured for heating using the trace design shown in FIG. 8A.

FIGS. 11A and 11B show top views of trace designs used to evaluate the heating performance of transparent heater elements prepared with platinum coated silver nanowires.

FIG. 12A is a plot of the change in temperature as a function of power density for heater elements prepared with platinum coated silver nanowires and configured for heating using the trace designs shown in FIGS. 11A and 11B.

FIG. 12B is a plot of the change in temperature as a function of voltage for heater elements prepared with platinum coated silver nanowires and configured for heating using the trace designs shown in FIGS. 11A and 11B.

FIGS. 13A and 13B show thermal images of heater elements prepared with platinum coated silver nanowires and configured for heating using the trace design shown in FIG. 11A.

FIG. 14 is a top view of a trace design used to evaluate the heating performance of transparent heater elements prepared with platinum coated silver nanowires.

FIG. 15A is a plot of the change in temperature as a function of power density for heater elements prepared with platinum coated silver nanowires and configured for heating using the trace design shown in FIG. 14.

FIG. 15B is a plot of the change in temperature as a function of voltage for heater elements prepared with platinum coated silver nanowires and configured for heating using the trace design shown in FIG. 14.

FIGS. 16A and 16B show thermal images of heater elements prepared with platinum coated silver nanowires and configured for heating using the trace design shown in FIG. 14.

FIGS. 17A and 17B are plots of temperature as a function of time for heater elements prepared with platinum coated silver nanowires and configured for heating using the trace design shown in FIG. 14.

FIG. 18 is a schematic top down view of a trapezoid shaped heater with a conductive layer between nonparallel metal traces, with approximate dimensions to indicate size and shape of the conductive layer.

FIG. 19A is a schematic top down view of a trapezoid shaped heater with a conductive layer between nonparallel metal traces, with positive and negative terminals located on opposing metal traces along the short side of the heater.

FIG. 19B is a schematic top down view of a trapezoid shaped heater with a conductive layer between nonparallel metal traces, with positive and negative terminals located on opposing metal traces along the long side of the heater.

FIG. 20A is a thermal image of a coated sample configured as a trapezoid shaper heater with positive and negative terminals located on opposing metal traces along the short side of the heater.

FIG. 20B is a thermal image of a coated sample configured as a trapezoid shaped heater with positive and negative terminals located on opposing metal traces along the long side of the heater.

FIG. 21 is a schematic top down view of a trapezoid shaped heater with a conductive layer between nonparallel metal traces, with conceptual horizontal lines extending across the conductive layer dividing the layer into ten zones.

FIG. 22A is a thermal image of a coated sample configured as a trapezoid shaped heater with positive and negative terminals located on opposing metal traces along the long sides of the heater, with the coated sample having a coating that is unetched.

FIG. 22B is a thermal image of a coated sample configured as described for FIG. 22A, with the coating horizontally etched with lines.

FIG. 22C is a thermal image of a coated sample configured as described for FIG. 22B, with the coating horizontally etched with a fewer number of lines as compared to the coating of FIG. 22B.

FIG. 23A is a thermal image of a second transparent heater prepared and configured as described for FIG. 22A.

FIG. 23B is a thermal image of a second transparent heater prepared and configured as described for FIG. 22B.

FIG. 23C is a thermal image of a second transparent heater prepared and configured as described for FIG. 22C.

### DETAILED DESCRIPTION OF THE INVENTION

Thin films formed from metal nanowires, such as noble metal coated silver nanowires, can be used to form heating elements that can carry sufficient current to provide a surface power density high enough to heat the surface while not degrading the conductive element. In some embodiments, the heater film is transparent to visible and/or infrared light so that the heater can be used to help remove ice or frost that can cloud visualization through the structure, which generally involves a transparent substrate supporting the heater. The conductive coating can also function as heater for a variety of other applications where a surface, component, or element is heated and transparent. The heater properties can be balanced with the desired optical properties to define the design parameters. The application of the heater can set a range of available voltage for the heater so that electrical resistance of the heating element can be selected to produce the surface power density compatible with the voltage. Silver nanowires have been developed for use in transparent conductive films for use in transparent touch sensors. Silver nanowire based inks can be coated on the surface of a wide range of materials, which allows for heaters arranged on a surface of a range of structures. In some embodiments, noble metal coatings on the silver nanowires enable the generation of higher surface power densities without damaging the heater, to provide useful heating for a wider range of applications. The conductive films for the heaters can be flexible and bendable, as well as conformable to irregular shapes, which can be a significant advantage relative to some alternative technologies. To the extent that the heater element itself has an irregular shape (non-rectangular), the heater can be designed to provide more uniform heating over the irregularly shaped structure, and these heater designs can be effectively adopted for various transparent resistive materials, including the noble metal-based materials, silver nanowires without the noble metal coatings, other metal nanowires, with or without noble metal coatings, transparent metal oxides, such as indium tin oxide, nanocarbon based resistive materials and the like. Without design modifications, an irregularly shaped heater element can produce a more uneven surface power density across the heater element if the resistivity is uniform across the heater surface and the voltage is uniform along an edge of the heated surface.

Formation of the heaters generally comprises coating and processing a transparent conductive film. Based on the transparent conductive film, electrodes can be applied to provide for electrical connection to supply power to the heater. In the art, such electrodes can be alternatively referred to as busbars or metal traces or possibly similar terms, which are clear based on the context. Metal wires can be attached to the electrodes, and the metal wires can be connected to a power supply to complete a circuit. The formed heater structure can be laminated or molded to the surface to be heated, or the heater structure can be formed on the surface and a protective hardcoat or other protective material, such as a polymer and/or glass, can be placed over the heater to protect the surface. The conductive films can be formed from solution with a suitable binders as process aids or to improve film properties—for example adhesion. Thus, in some instances a transparent heating layer can be created by direct deposition of a nanowire, such as a platinum coated nanowire, ink onto another component (for example, a camera lens, or a component of a Light Detection and Ranging (LiDAR) system) eliminating the need for a distinct transparent, e.g., polymeric, substrate.

To protect the heater from damage, a polymer overcoat can be provided. Generally, the polymer overcoats can be useful for any transparent conductive film. To provide suitable protection against possible abrasion or other damage, the overcoat and/or a further protective coating, potentially with multiple layers, can comprise a hardcoat polymer to provide scratch resistance with a sufficient overall thickness to adequately protect the heating element. To reduce thermal insulation caused by a thicker protective coating, the coating or portion thereof can be loaded with a thermally conductive nanoparticle filler. Improvement of the thermal conductivity through the protective coating can improve the efficacy of the heater. Through the use of suitable nanoparticles to improve thermal conductivity, the light transmittance and other optical properties can be changed within acceptable limits. Also, a surface coating of a photoactive material can provide a self-cleaning capability through exposure to ambient UV light, such as from sunlight, to oxidize dirt and other debris so that it can be easily washed away. Improved protective coatings can be effective even with other transparent conductive film materials, such as formed with transparent conductive oxides, such as indium tin oxide, or carbon nanotubes.

To form devices, the conductive films can be cast directly onto the structure to have the heated surface. In additional or alternative embodiments, the conductive film can be formed on a polymer sheet as a substrate that is then laminated to the structure to have the heated surface, which is a possible process approach due to the flexibility and formability of nanowire based coated polymer sheets and films. The sheets and films can be formed in a roll-to-roll process. Processing can be performed at lower temperatures, and in some embodiments at or near room temperature. For an actual device, the heater has bus bars or the like as electrodes to connect the heater element to a power source and control system, which can be placed in a bezel region for a transparent structure. Adaptation of the heater element for embodiments not having a rectangularly arranged electrodes/bus bars are described to provide reasonable uniformity of power density generated across the heater.

It has been discovered that noble metal coated silver nanowires provide significantly improved stability in a heater format relative to corresponding heaters with uncoated silver nanowires, to provide for effective thin film heating elements that can be useful in a range of applications. Silver nanowire synthesis has developed to the point of commercial scale synthesis with very good nanowire properties. Effective coating processes can be used to apply suitable noble metal coatings onto the commercial scale silver nanowires. The noble metal coated silver nanowires provide a cost effective and commercial scale component for effective structure production. Due to the improved heat stability, and corrosion resistance, the resulting heater can then provide an effective amount of heat without sacrificing processability or desirable coating properties.

The use of metal nanowires for the heating element provides for the possibility of very thin layers for the heating element. The heating element can be transparent with ranges of transparency from highly transparent to translucent. Generally, more transparent and less hazy elements have a greater electrical resistance which should be accounted for in the overall design. Transparency can be in the visible wavelengths for displays and windows and/or in the infrared for machine vision systems, such as LIDAR. Low voltage constraints, overall heater design and size, and other factors may provide tradeoff between level of transparency and the surface power density.

Transparent conductive heaters are known based on transparent electrodes formed with conductive ceramic oxides, such as indium tin oxide (ITO). See, for example, U.S. Pat. No. 5,354,966 to Sperbeck, entitled “Window Defogging System With Optically Clear Overlay Having Multi-Layer Silver Bus Bars and Electrically Isolating Peripheral Grooves,” and published PCT application 2022/136102 to Gallinelli et al., entitled “Glazing Having an Electrically Heatable Communication Window for Sensors and Camera Systems,” both of which are incorporated herein by reference. Since ITO is a ceramic material, it is not flexible or bendable, although if thin enough it may be slightly flexible. Metal meshes can be formed into relatively thin and potentially somewhat flexible heaters, although these materials are not as flexible, as thin, or as low temperature processable. As with ITO, the processing with metal mesh can require significant heating, which limits the materials and can pose other significant constraints on processing. Moreover metal meshes have large gaps between metal lines or conductors which can be undesirable for many applications. There are also often limitations to producing metal mesh and metal oxides on a variety of relevant substrates such as polycarbonate. Furthermore, these conductors generally have challenges to be deposited directly onto a curved surface, a two-and-a-half-dimensional (2.5D) surface, such as an assembled stack of two dimensional materials, or a three-dimensional (3D) textured surface.

The nanowire based heaters can be formed using several possible approaches and on a wide range of materials. Since the systems are solution based, the layers forming the heating elements can be directly coated onto a substrate to support the heater. A direct coating approach can be applied to reasonable surface shapes. Slot-die coating is a well-established technique for nanowire coating. See, for example, published U.S, patent application 2020/0245457 to Chen et al., entitled “Thin Flexible Structures with Surfaces With Transparent Conductive Films and Processes for Forming the Structures,” incorporated herein by reference. In further embodiments, the nanowire solutions can be spray coated onto the target surface with a sufficiently large nozzle opening to avoid clogging. Dip coating using the noble metal coated silver nanowire inks can also be suitable for some substrates. Direct coating of nanowire inks can be performed on flat or curved substrates made from wood, paper, fabric, polymers, such as polycarbonate (PC) and polymethyl methacrylate (PMMA), and the like. In additional or alternative embodiments, the heating elements can be coated onto a flexible polymer sheet. Due to the excellent flexibility of silver (and metal coated silver) nanowire based conductive films, the heater can successfully perform on the flexible polymer sheet that maintains its flexible format. As described further below, it is generally desirable to provide fusing of the nanowires into fused metal nanostructured network using Applicant's proprietary technology.

Slot coating type of coating processes for the metal nanowires, such as noble metal coated silver nanowires, are readily applicable to coating onto polymer sheets, which can be performed in a roll-to-roll format. Such a roll-to-roll process is generally used for forming transparent conductive electrodes for touch senor formation for portable electronic devices, whether or not the ultimate device is fixed, foldable or flexible. The roll-to-roll formation of the heater element on a polymer sheets and films can adapt established roll-to-roll deposition techniques for metal nanowires for forming heater structures for various devices. The use of roll-to-roll coatings onto a flexible polymer sheet can be useful for application of the heating element onto various shaped surfaces since the polymer sheets with the heating elements can be conformed to a target surface. Attachment techniques are described further below. Other deposition techniques include spray-coating, flow-coating, slit-coating, inkjet printing, and dip coating, and these approaches can be useful in particular to direct application to a range of surfaces. Based on these processing options, the transparent heating elements can be formed on a range of devices.

Silver nanowires can be synthesized as described in U.S. Pat. No. 10,714,230 to Hu et al. (hereinafter the '230 patent), entitled “Thin and Uniform Silver Nanowires, Method of Synthesis and Transparent Conductive Films Formed From the Nanowires,” incorporated herein by reference. The '230 patent involves improved implementation of synthesis approaches based on a glycol solvent/reducing agent and a polyvinyl pyrrolidone capping agent. Commercial nanowires are synthesized based on the teachings of the '230 patent. In general, thicker nanowires can be formed more economically, while thinner nanowires can be useful for some improvements in optical properties for transparent structures. The formation of noble metal coatings on silver nanowires is described in U.S. Pat. No. 9,530,534 to Hu et al. (hereinafter the '534 patent), entitled “Transparent Conductive Film,” incorporated herein by reference. The '534 patent described methods based on either galvanic exchange or direct deposition to apply the noble metal coatings. The '534 patent exemplified coatings of gold and platinum, and discusses applicability for noble metals, iridium, rhodium, palladium and osmium. The amount of noble metal coating is generally driven by the amount of coating precursor that is added and the specific reaction conditions chosen.

Silver nanowire based heaters can be formed using Applicant's proprietary fusing technology that transforms the silver nanowires into a unitary conductive structure to provide improved electrical conductivity without diminishing optical properties as well as providing mechanical stabilization, including with respect to bending or stretching the conductive film. While fusing may not be used to form metal nanowire based heaters, fusing may be useful to achieve desired performance levels or reduced metal use. The fusing is believed to occur at least primarily during drying of the ink as the solvent evaporates. The evaporating solvent concentrates the species driving the rejection. It has recently been discovered that the fusing can be driven to occur at or near room temperature such that no heat is necessary to be applied during the fusing into a fused metal nanostructured network. Room temperature fusing is described in published U.S. patent application 2023/0416552 to Yang et al. (hereinafter the '552 application), entitled “Formation of Electrically Conductive Layers at Room Temperature Using Silver Nanoparticulate Processing and Inks for Forming the Layers,” incorporated herein by reference.

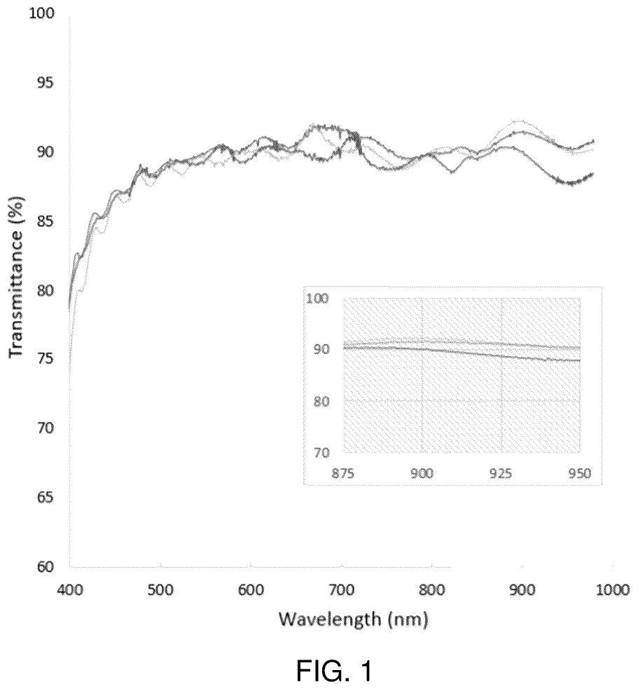

The heaters are generally desired to be incorporated into a transparent structure. With the range of structures that can effectively use the heater, the nature of the transparency may be distinct from optical properties associated with, for example, a display or the like. For example, the structure may be transparent in only a portion of the spectrum. A machine vision device may need transparency in the infrared, but not necessarily in the visible. As another example, car windows may be tinted to limit glare. Some systems are designed to block UV light. In any case, the structure with the heater generally has a transmittance over a useful spectral range from the infrared to the visible at is at least about 70%. For imaging systems operating in the infrared, the relevant spectral region can be from 750 nm to 1750 nm or a selected portion thereof. For optical systems used for human vision, such as a vehicle window, the transmittance over all or a significant portion of the visible spectrum (which can be set from 400 nm to 750 nm or a different range if desired) is at least about 70%, although in some embodiments it can be significantly more transparent, such as a transmittance of at least about 80%. A representative set of transmittance measurements are presented in FIG. 1 for transparent silver nanowire films formed with a sheet resistance of 30-50 Ohms/sq on either a polyethylene terephthalate optical film or a polycarbonate optical film. Over most of the relevant wavelength range, the transmittance with the substrate is >90% and corresponding values with the substrate transmittance removed would result in transmittance values just for the conductive layer of >95%.

### Heater Structure

The overall heater structure generally comprises electrodes, busbars or the like as driving electrodes framing and connecting the thin film heating element with a power source and controller through the driving electrodes. As used herein and as conventional in the field, a busbar refers to highly conductive, non-transparent electrodes or metal traces that provide for application of an electrical potential and resulting current across a transparent conductive film to generate heat. The electrodes can be formed using materials available in the art, such a silver paste or other convenient product. The electrodes do not form a patterned grid with significant regions of conductive and non-conductive material, such that current generally flows from one side of the heater element to the other side to generate a desired power output density. Generally, the electrodes are placed at or near the outer edges of the transparent conductive film such that significant portions of the transparent conductive film are not outside of the circuit formed by the electrodes. The electrodes/busbars are provided with at least two opposite polarity elements, and additional electrode elements (more than one of at least one polarity) can be used to provide more uniform current flow through the heating element. Respective members of a pair of electrodes may or may not have the same length as each other. If a plurality of pairs of electrodes are provided, the respective pairs of electrodes can have different voltages set between the electrode pairs to provide a more uniform heating across a non-rectangular heating element. The busbars can be formed with metal traces, conductive metal paste or similar metal structure that can be formed at a suitable point in the assembly process. The bus bars generally cover a significantly smaller area compared with the thin film heating element and generally is expected to have a much lower resistance contribution to the overall circuit. The power source is generally dependent on the particular application and whether or not a stationary location. For example, suitable power sources can be a battery, with or without a transformer to control voltage, a transformer connected to a line voltage, or any other suitable power source. A control device can be as simple as a switch to turn on or off a fixed voltage, a switch with an adjustable voltage, a digital processor with an associated power supply, or any other reasonable controller.

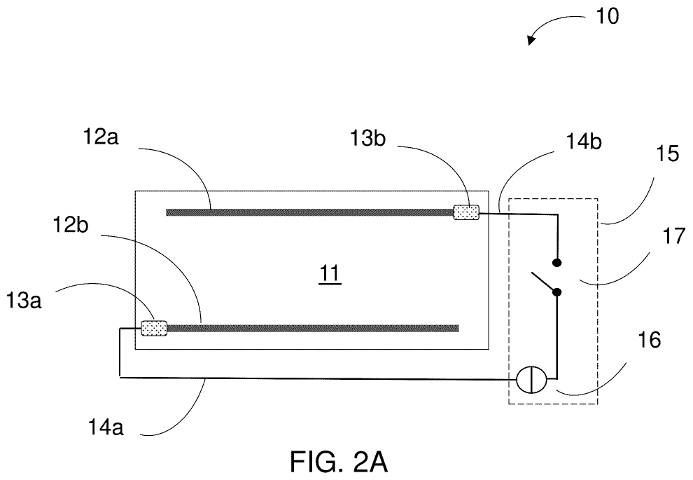

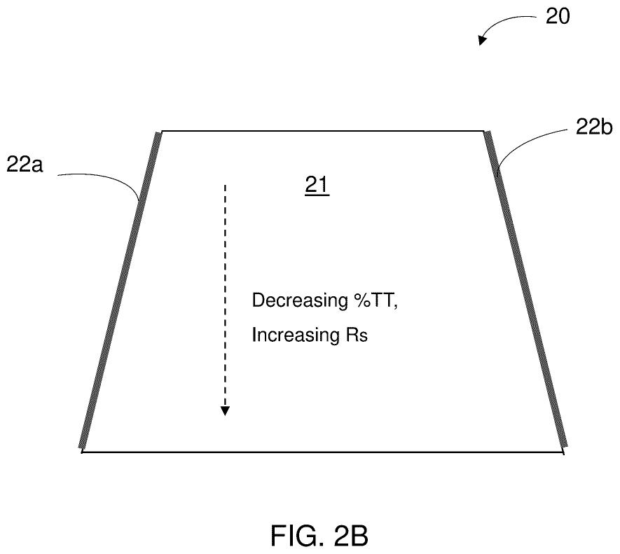

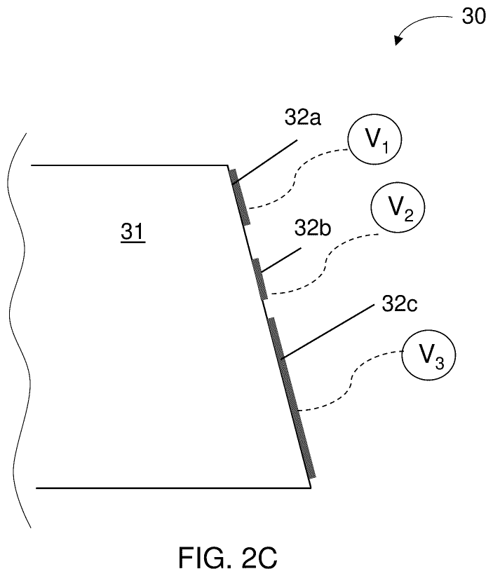

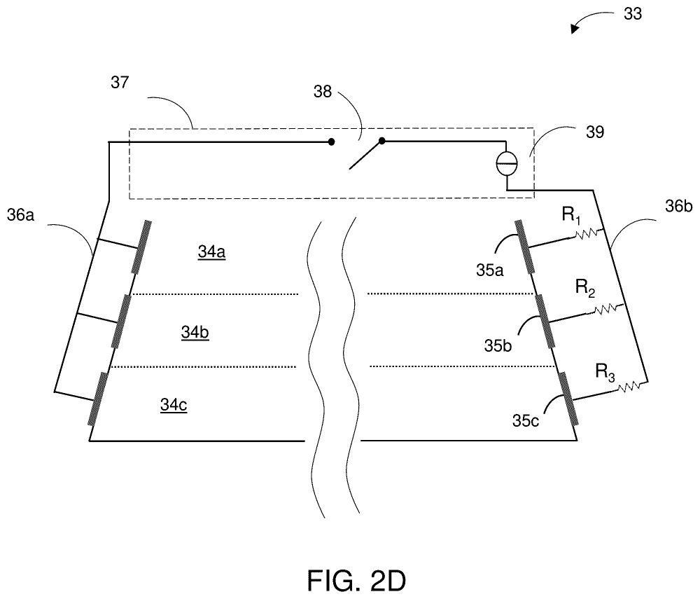

FIG. 2A shows a general layout of a heater (top view) with the transparent nanowire based heating element and supporting bus bars and controls. In the depicted embodiment, the heater element is approximately rectangular. Heater 10 comprises coated sample 11 including a coating of nanowire based ink on a support, such as a transparent support. In some embodiments, the heater is placed on a non-transparent support, in which case the transparency of the heater allows for an unobstructed view of the support surface that may be decorative. Metal traces (electrodes) 12a and 12b are formed on the nanowire based coating so as to provide heating across the coating when power is supplied. Trace 12a is connected via area 13a to wire 14a. Trace 12b is connected via area 13b to wire 14b. The particular design, i.e., placement, width, and number of traces may vary, and several designs were evaluated as described below for the examples. Trace 12a us parallel and of the same length as trace 12b to form an essentially rectangular heater surface. The dimensions of coated sample 11 can be any dimensions depending upon the particular application. Particular sizes for coated samples 11 as test samples are described below for the examples. Controller 15, comprising power supply 16 and switch 17, is configured to supply power as desired and may also comprise additional elements such as a digital processor or analogue circuits.

Performance of the heater is simplest with a structure where the electrodes/bus bars or a substantial portion thereof are arranged parallel to each other to form a roughly rectangular heating element. For these configurations, neglecting edge effects and other relatively minor potential design asymmetries for connecting the electrodes, the heat generated is generally approximately uniform across the heater. If substantial sections of the electrodes/bus bars are not parallel to each other or have significantly different lengths, the electrical current across the heater element would not be uniform if the sheet resistance of the conductive film forming the heater element is uniform. This is shown schematically in FIG. 2B for trapezoid shaped heater 20 comprising conductive film 21 and supporting bus bars 22a and 22b. If the heater material is uniform across the surface of the heater and the opposite polarity electrodes are not parallel, the power density generated across the heater surface is not uniform across the surface of the heater. As described herein, properties of the transparent conductive film forming the heater element can be altered to improve the uniformity of the surface power density such that the heat generated across structures adjacent the heater element can be more uniform such that more effective heating functionality can be observed. As explained further below, as the shortest length between adjacent points of opposite polarity electrodes changes along the length of the electrodes, the resistance at relevant locations of the heater element can be adjusted along the heater surface to improve the uniformity of the surface power density.

In principle, the electrode shapes can be altered to attempt to direct more uniform current through the transparent heating element. To perform such modifications to the current flow, the electrodes could be altered to induce electrical resistance at appropriate places in the electrodes/bus bars that correspondingly result in portions of the electrode being at a different voltage than other portions of the electrode. Having a voltage drop in the electrode itself would result in significant heat generation in the electrodes. This would be undesirable since heat at the electrodes would not be efficient to heat the desired portion of the device, which is transparent, so a resulting waste of power would result. The designs described herein avoid these complications.

In additional or alternative embodiments, the electrodes can be subdivided, such that a different voltage can be applied to elements of the subdivided electrodes to provide more uniform heating, although this approach involved altered power supplies to provide the plurality of voltages. This embodiment is shown in FIG. 2C in which a portion 30 of a heater comprising conductive film 31 and segmented metal traces 32a-32c, each electrically configured to be driven at the same or different voltages V₁-V₃. The use of the in series resistors provides a convenient way to effectively adjust the effective current across the heater segments since the total resistance increases for a fixed voltage—V=IR=I(Rₕ+Rᵣ)=I Rₕ+I Rᵣ, where Rₕ is the resistance of the heater segment, Rᵣ is the resistance of the in series resistor.

It may be desirable to form thin etch lines also along the transparent conductive film to form isolated conductive stripes. The etching of the transparent conductive film can be a thin line that limits any electrical conduction between adjacent stripes while thermal conduction effectively results in a uniform heated surface without gaps, but with a more uniform surface power density.

In additional or alternative embodiments, the isolated conductive stripes, such as with thin etched lines to electrically isolate the stripes of heater material, can be electrically configured such that a different voltage can be applied to each of the stripes to provide more uniform heating. This embodiment is shown in FIG. 2D in which heater 33 comprising three isolated conductive stripes 34a-34c are electrically configured in series with pairs of metal traces (electrodes) 35a-35c, respectively. Resistors R₁-R₃ and wires 36a and 36b connect the pairs of electrodes to controller 37, comprising power supply 39 and switch 38, configured to supply power as desired. Heater 33 may comprise additional elements such as a digital processor or analogue circuits. Resistors R₁-R₃ have different resistances and are arranged such that the voltage delivered to each isolated conductive stripe is different and uniformity of heating is improved.

The heater is generally supported on a substrate as formed, though a transparent conductive heating layer can also be deposited directly onto another layer, component or element—for example by spray or flow coating. Conductive nanowire based layers can have a polymer overcoat for stability during processing, but a polymer overcoat is not needed. In some instances, other layers, encapsulates, anti-reflective coatings, adhesives, and sealants may also provide improved stability and reliability thereby making the use of an overcoat unnecessary. Additionally other conductive materials, or layers and components which distribute or modify the heat and its dissipation may be applied directly to the conductive coating, or onto the polymer overcoat. An optional polymer overcoat is generally thin enough to allow for electrical conduction through the overcoat. Of course, in the final structure, the nanowire based conductive layer would be expected to have some protective cover so that it is not damaged during use, which may be applied once electrical connections are completed to provide connectivity, or electrical connections can be made through windows in an insulating cover. Details of potential overcoats are discussed further below in the context of the device structure.

As noted above, various coating methods can be used to apply the metal nanowire based conductive precursor ink. For heater applications, the ultimate product may not have flat or rectangular shape. Depending on the production protocols for the device itself, It may or may not be appropriate to coat the nanowire precursor solution directly onto a surface of the transparent structure forming the core of the actual device, such as a glass surface. A protective cover then would be applied with or without a thinner overcoat initially.

If the conductive layer is applied directly onto the structure to incorporate the heater, then, further processing can be performed over the conductive layer. A protective polymer or glass layer may be laminated over the conductive layer or applied with an adhesive. In some embodiments, a protective polymer coating can be coated over the transparent heater surface with or without an overcoat layer over the heater surface. The top-most layer can be a scratch resistant hardcoat or other suitable material. Such a protective cover can comprise an optically clear polymer substrate laminated with an optically clear adhesive. The optically transparent substrate material can have a hardcoat surface.

Suitable commercial polycarbonate substrates include, for example, MAKROFOL SR243 1-1 CG, commercially available from Bayer Material Science; TAP® Plastic, commercially available from TAP Plastics; and LEXAN™ 8010CDE, commercially available from SABIC Innovative Plastics. Optical quality PET substrates are available from, for example, DuPont-Teijin and Toray Films (Lumirror™). Polyimide substrates are available from Kolon, and polysulfone substrates are available from Solvay. Cyclic polyolefins (COP) are available from Zeon Corporation. Optically clear adhesives are available commercially as a liquid adhesive or as an adhesive tape, which can be two sided. Suitable clear adhesive tapes are available commercially, for example, from Lintec Corporation (MO series); Saint Gobain Performance Plastics (DF713 series); Nitto Americas (Nitto Denko) (LUCIACS CS9621T and LUCIAS CS9622T); LG Hausys OCA (OC9102D, OC9052D); DIC Corporation (DAITAC LT series OCA, DAITAC WS series OCA and DAITAC ZB series); PANAC Plastic Film Company (PANACLEAN series); Tesa SE (Germany) (AF61, 694 series, 696 series, and 697 series); Minnesota Mining and Manufacturing (3M, Minnesota U.S.A.—product numbers 8146, 8171, 8172, 8173, 1414-1, 9894, and similar products) and Adhesive Research (for example product 8932). These companies may also sell optically clear liquid adhesives.

In some embodiments, a conductive nanowire layer is applied to a polymer substrate to facilitate heater formation. In these embodiments, a thin polymer overcoat can be desirable to protect the conductive heater layer during and prior to further processing. This processing approach has an advantage of providing a product, polymer with a transparent conductive layer for forming a transparent heater, that can be adapted for a range of applications. Fused metal nanostructured networks have been shown to be adaptable to formation, which may involve bending and/or stretching. See, for example, U.S. Pat. No. 11,343,911 to Kambe et al., entitled “Formable Transparent Conductive Films with Metal Nanowires,” incorporated herein by reference.

If the conductive nanowire layer is applied to a polymer sheet that is to be attached to an ultimate structure to have a heated surface, the polymer film with the conductive layer can be attached with an adhesive selected to be suitable for the particular structures, such as a contact adhesive or a transparent adhesive. Additional layers can be applied as appropriate. Especially in the context of roll-to-roll processing as well as other embodiments, a thin polymer overcoat can be placed over the transparent conductive layer, which is generally thin enough to avoid significant electrical resistance through the overcoat. A polymer overcoat can provide protection to the conductive layer during processing, a desirable uniform surface for placement of additional layers during processing, an index of refraction to reduce undesirable changes of index through the optical stack, and possibly other advantages. While the conductive heating element should have some protective covering, a suitable covering should not be excessively thermally insulating since generally the heating element is intended to heat the surface of the ultimate structure. Furthermore, one can coat a thin protective layer, and then apply the bezel materials to make good electrical contact, and then apply a thicker protective coating thereby ensuring both good electrical connectivity and good reliability and durability.

In another embodiment, a flexible layer with the transparent heating element can be secured to the device surface to be heated using an insert molding or over molding process. The structures are aligned and polymer is injected to complete the structure in which the injected polymer forms the protective coating along the exterior surface. The injected polymer can be polycarbonate, polymethylmethacrylate, acrylonitile butadiene styrene (ABS) polymer, or other suitable polymer. Additional discussion of device structures is described below. The transparent conductive film is discussed in detail in the following section.

### Transparent Conductive Heater Film

The formation of a metal nanowire based transparent conductive film involves forming a thin coating of metal nanowires at a density that provides nanoscopic gaps between the nanowires dispersed in a random pattern. Since the diameters of the nanowires are generally significantly smaller than the wavelength of visible light, the layer has the appearance of a uniform transparent film with optical properties, such as haze and transmittance, determined by the properties of the nanowires and the amount of metal deposited. Fusing the nanowire junctions with chemical fusing can increase electrical conductivity without degrading the optical properties, while also improving the mechanical resilience of the conductive structure.

The design of the thin film heater can depend on the desired use. With respect to the use, the amount of metal deposition and characteristics of the metal nanowires generally frames the nature of the heating element, which can balance electrical resistance and transparency. In particular, to maintain transparency through the film, the resistance cannot be arbitrarily adjusted independent of the transmittance or optical clarity and haze. If the voltage can be adjusted, the voltage can be used to set the surface power density based on the resistance of the heating element. Since the primary objective of the heating element would be heating, these parameters are discussed next.

For a heater, a significant performance measure can be the power output per unit area, which can also be referred to as surface power density. While other design parameters, such as heat capacity of other materials, as well as the environment may influence the resulting surface temperature, the temperature generally is a function of the power output (roughly linear) of the heating element for a given structure. The power output depends on the electrical resistance of the heating element and the applied voltage. In embodiments of particular interest, the heating elements described herein incorporating noble metal coated silver nanowires are capable of tolerating significantly greater power output without failing relative to comparable heated based on silver nanowires without a noble metal coating. The surface power density is a device level parameter since it depends on the current across the heater element, which in turn depends on the electrical resistance. The area of the device can be measured, and the resistance can be evaluated using a multimeter. Assuming a uniform structure with a rectangular configuration, the surface power density (P_{d}) can then be evaluated as, P_{d}=V²/(R·A), where V is the voltage across the heater, R is the resistance and A is the area of the heater. If V is in volts and R is in Ohms, P_{d} is in watts divided by the units of A. Sheet resistance (Rₛ) is equal to resistance times the width of the resistive element divided by the length of the resistive element, Rₛ=R w/L, where w is the width of the heater structure orthogonal to the current flow and L is the length of the heater structure along the current flow. Rₛ can be conveniently measured for conductive films. In the present applications, the sheet resistance of the transparent conductive film can be from about 0.5 Ohms/sq to about 250 Ohms/sq and in further embodiments from about 1 Ohms/Sq. to about 250 Ohms/sq and in additional embodiments from about 2 Ohms/sq to about 150 Ohms/sq. Formation of fused metal nanostructured networks and sparse metal conductive films with lower values of sheet resistance and corresponding transmittance is described in copending U.S. patent application Ser. No. 18/212,297 to Yang et al., entitled “Formation of Electrically Conductive Layers at Room Temperature Using Silver Nanoparticulate Processing and Inks for Forming the Layers,” incorporated herein by reference. Noble metal coated silver nanowires can exhibit values of Pa greater than about 0.5 W/cm² (5000 W/m²), in some embodiments greater than about 0.6 W/cm², and in some embodiments at least about 1 W/cm². In addition to tolerating higher surface power density without failure, the noble metal coated silver nanowires are suitable for use in devices over expected product lifetimes at useful power output. For extended use, the surface power densities can be at least about 0.05 W/cm², from about 0.2 W/cm² to about 1.5 W/cm² and in other embodiments from about 0.1 W/cm² to about 1.25 W/cm². A person of ordinary skill in the art will recognize that additional ranges of power per unit area and sheet resistance within the explicit ranges above are contemplated and are within the present disclosure.

The evaluation of the surface power density is relatively straightforward for a rectangular heater configuration, but the simple formulation based on an assumed constant resistivity and current across the area does not account for potential variation in the local surface power density. Assuming electrical current flowing between to electrodes, the surface power density can be expressed in terms of voltage V, sheet resistance Rₛ and a length L, P_{d}=V²/(Rₛ·L²), where L is the length between the electrodes. Sheet resistance Rₛ can be a function of position along the heater surface. There are many potential ways to address a non-uniformity due to a non-rectangular shape of the heater surface, and the degree of complexity should be balanced with the practical realities that heat also spreads and is not a confined local parameter, so a reasonable approximation should work well. To this end, alternative approaches are provided for altering the resistivity along the heater surface to improve the uniformity of the heat generation.

The resistance values generally depend on the characteristics of the heater coating, including metal surface loading, which can be expressed in mg/cm². With enough metal deposited, the electrical conductivity can approach that of bulk metal, although the processing does not involve melting into a single mass to eliminate electrical resistance within the mass. For transparent heaters, the metal loading and corresponding amounts of metal are correspondingly limited. The deposit metal is in the form of what can be referred to as a sparse metal conductive layer, in which the metal nanowires are sufficiently sparse, there is appropriate visibility through conductive layer. Improved optical performance generally can be achieved with comparable electrical performance using a fusing process to form fused metal nanostructured networks, as explained further below. The fusing process can be achieved at low process temperatures and have been effectively achieved at room temperature processing. This dependence of the resistance to the metal surface loading provides an approach to alter the heat generated at various locations along the heater surface by altering deposition density and/or selective removal of metal accordingly to achieve more uniformity of heat generation.

In the context of some loaded polymer systems, noble metal coated silver nanowires have been found to provide surprisingly improved conduction properties. In the context of bulk metal nanowire loaded polymers, in certain polymeric systems, platinum-coated silver nanowires exhibit improved electrical conductivity and a lower percolation threshold with respect to metal loading in comparison with silver nanowires. These properties are described in copending U.S. patent application Ser. No. 18/376,952 to Virkar et al., entitled “Silver Nanowire and Noble-Metal Coated Silver Nanowire Conductive Polymer Composites With Low Loading Percolation Conduction,” incorporated herein by reference. When formed into transparent conductive layers with fused metal nanostructured networks, the noble-metal coated silver nanowires are not found to exhibit a corresponding drop in sheet resistance, see the '534 patent cited above.

With respect to transparent conductive layers used as heating elements, there is a tradeoff between metal loading and transmittance. If more metal is loaded, the transmittance generally decreases, and the electrical resistance also generally decreases. For a fixed voltage, a lower resistance produces more power output in the form of heat. To the extent that a higher transmittance is desired, a lower metal loading can be used at the expense of an increase in sheet resistance. The use of thinner nanowires can allow for some increased transmittance and lower haze for a fixed metal loading, although thinner nanowires are generally more expensive to produce. The loading levels of the nanowires can provide a useful parameter of the network that can be readily evaluated, and the loading value provides an alternative parameter related to thickness. Thus, as used herein, loading levels of nanowires onto the substrate is generally presented as milligrams of nanowires for a square meter of substrate. In general, the nanowire networks can have a loading from about 1 milligrams (mg)/m² to about 2000 mg/m², in further embodiments from about 2.5 mg/m² to about 400 mg/m², and in other embodiments from about 5 mg/m² to about 300 mg/m². A person of ordinary skill in the art will recognize that additional ranges of thickness and loading within the explicit ranges above are contemplated and are within the present disclosure.

Components used in various applications can have certain voltages available for use to drive the heater. Also, the voltage can be used to provide a desired surface energy density if adjustable voltage is an option. It may or may not be desirable to provide voltage transformation, which involves spatial considerations, energy loss and potentially some cost considerations. Handheld portable devices can operate at 5V, while stationary devices can draw on line voltages of 120V or 240V, which may be dependent on the location. In some applications, such as electric vehicles, power sources up to 1000V may be available. So for most applications, the heaters can be designed for operations from 1V to 1000V, in some embodiments from 2 V to 20V, and in other embodiments from 5V to 120V. In general, the voltage can be provided by a direct current (DC) or an alternating current (AC). Automobile batteries can supply 12V, while some trucks have battery systems with 24V output. Generally, the heater can be designed for operation at the appropriate voltage window. As noted, in some embodiments, a bus bar can be segmented so that segments of the bus bar can be set at different voltages. These embodiments are described further below. A person of ordinary skill in the art will recognize that additional ranges within the explicit ranges above are contemplated and are within the present disclosure.

Transparent conductive films are generally evaluated in terms of sheet resistance in Ohms/square, which can be evaluated without measurement of the layer thickness. For touch sensor applications, the sheet resistance is an effective evaluation of the performance in such devices. It can be directly measured along the surface of the material and more generally it is used to characterize materials with an effectively uniform thickness. Whether or not transparent conductive films are uniform thickness in a microscopic sense is not directly relevant, but they are sufficiently uniform in an operational sense, that use of a sheet resistance makes sense. For a heater, which operates at significant power output, the resistance of the electrical circuit is significant and can be evaluated using conventional circuit measurements using Ohm's Law, V=IR. So the current is measured at an applied voltage, for example using an Ohm meter (multimeter) or the like to obtain R=V/I.

Roughly, the resistance depends on the sheet resistance and the configuration of the heater construction, including placement of the electrodes. With a uniform layer thickness, resistance and sheet resistance can be interconverted readily. A target resistance value can depend on the desired transmittance, available voltage and desired power output. Of course, these are not individually adjustable parameters. The nanowire loading can be used to adjust the sheet resistance, which correspondingly changes the transmittance. For effectively symmetrical electrodes over a rectangular shape, the heater element can have roughly uniform nanowire loading while providing roughly uniform heat generation. Adjustments for other electrode geometries are discussed further below. To the extent that the voltage is adjustable for the particular application, the voltage can then provide an additional adjustable parameter. Similarly, during the design phase, to the extent that the bus bars/drive electrodes can have flexible placement, having a shorter path length between the bus bar poles would generally result in a lower resistance value since the resistance is expressed as R=p LIA, where p is the resistivity, L is the length and A is the area. To the extent that bus bar placement provides for decreasing L or increasing A, the resistance can be decreased. In some embodiments, the resistance can be from about 1 Ohm to about 300 Ohms, in further embodiments, from about 2 Ohms to about 200 Ohms, and in other embodiments, from about 5 Ohms to about 100 Ohms. A person of ordinary skill in the art will recognize that additional ranges of resistance within the explicit ranges above are contemplated and are within the present disclosure.

To obtain optimal optical properties for the nanowire based transparent conductive films, Applicant has relied on its fusing technology to form the nanowires into a fused metal nanostructured network. The fusing process can be performed to allow thermodynamic controlled metal deposition to preferentially provide for metal being deposited at nanowire junctions. If the heater design allows for a higher resistance or reduced optical properties, it may be possible to use unfused nanowires to provide sufficient conductivity for the heater. Thus, while forming a fused metal nanostructured network may be desirable from the standpoint of improved performance, a heater may or may not involve forming a fused metal nanostructured network, which is unitary metal structure extending across the entire conductive element. A fused metal nanostructured network may also provide desirable mechanical and/or wear resistance that may be desirable in addition to improved electrical conductivity.

In general, various sparse metal conductive layers can be formed from metal nanowires, such as the noble metal coated nanowires. Films formed with metal nanowires that are processed to flatten the nanowires at junctions to improve conductivity is described in U.S. Pat. No. 8,049,333 to Alden et al., entitled “Transparent Conductors Comprising Metal Nanowires,” incorporated herein by references. Structures comprising surface embedded metal nanowires to increase metal conductivity are described in U.S. Pat. No. 8,748,749 to Srinivas et al., entitled “Patterned Transparent Conductors and Related Manufacturing Methods,” incorporated herein by reference. However, improved properties have been found for fused metal nanostructured networks with respect to high electrical conductivity and desirable optical properties with respect to transparency and low haze. Fusing of adjacent metal nanowires can be performed based on chemical processes under commercially appropriate processing conditions.

In particular, a significant advance with respect to achieving electrically conductive films based on metal nanowires has been the discovery of well controllable processes to form a fused metal network where adjacent sections of the metal nanowires fuse into a unitary structure without distinct nanowires in the conductive network. In particular, it was initially discovered that halide ions can drive the fusing of metal nanowires to form fused metal nanostructures. Fusing agents comprising halide anions were introduced in various ways to successfully achieve the fusing with a corresponding significant drop in the electrical resistance. It should be noted that halide ions in this processing context should not be confused with halide ions used in the nanowire synthesis reactions. Specifically, the fusing of metal nanowires with halide anions has been accomplished with vapors and/or solutions of acid halides as well as with solutions of halide salts. Fusing of metal nanowires with halide sources is described further in U.S. Pat. No. 10,029,916 to Virkar et al., entitled “Metal Nanowire Networks and Transparent Conductive Material,” and U.S. Pat. No. 9,920,207 to Virkar et al. (the '207 patent), entitled “Metal Nanostructured Networks and Transparent Conductive Material,” both of which are incorporated herein by reference.

An extension of the process for forming fused metal nanowire networks was based on reduction/oxidation (redox) reactions that can be provided to result in fused nanowires without destroying the optical properties of the resulting film. Metal for deposition at the junctions can be effectively added as a dissolved metal composition or can be dissolved from the metal nanowires themselves. The effective use of redox chemistry for fusing metal nanowires into a nanostructured network is described further in U.S. Pat. No. 10,020,807 to Virkar et al. (the '807 patent), entitled “Fused Metal Nanostructured Networks, Fusing Solutions with Reducing Agents and Methods for Forming Metal Networks,” incorporated herein by reference. The '807 patent also described a single solution approach for the formation of fused metal nanostructured networks. Single solution approaches for the formation of fused metal nanostructured layers are described further in U.S. Pat. No. 9,183,968 B1 to Li et al, (hereinafter the '968 patent) entitled “Metal Nanowire Inks for the Formation of Transparent Conductive Films with Fused Networks,” incorporated herein by reference, and single solution or ink processing to form fused metal nanostructured networks is used in the Examples below. The effective fusing of noble metal coated silver nanowires into fused metal nanostructured networks is described in the '534 patent cited above.

Silver is the metal with the highest electrical conductivity. Thus, silver salts have generally been used for fusing the nanowire junctions, and silver salts for fusing are exemplified below. But Applicant has successfully used a range of metals for performing the fusing process with silver nanowires using corresponding salts. See the '807 patent. In view of the present objective of forming a heater with desired durability, the use of higher melting metals for fusing may be desirable, since platinum coated nanowires, even with a very thin platinum coating, are found to stabilize the heater. Thus, for example, it may be desirable to perform fusing using palladium salts, such as P_{d}(NO₃)₂ or K₂PdCl₄, which were successfully used in the '807 patent. Palladium has a significantly higher melting point than silver, although not quite as high as platinum, and an electrical conductivity comparable to platinum. Of course, other metals can be used for fusing also if desired, such as nickel or rhodium, which have high melting points and good electrical conductivity.

The desirable inks to achieve effective single deposition inks that cure into fused nanostructured metal networks comprise a desired amount of metal nanowires to achieve appropriate loading of metal in the resulting transparent film. In appropriate solutions, the inks are stable prior to deposition of the ink and drying. The inks can comprise a reasonable amount of polymer binder that contributes to the formation of a stable conducting film for further processing. To obtain good fusing results with one ink systems, hydrophilic polymers have been found to be effective, such as cellulose or chitosan based polymers. Metal ions, as a source of metal for the fusing process, can be supplied as a soluble metal composition.

A single ink formulation provides for depositing a desired loading of metal as a film on the substrate surface and simultaneously providing constituents in the ink that induce the fusing process as the ink is dried under appropriate conditions. These inks can be referred to conveniently as fusing metal nanowire inks with the understanding that the fusing generally does not take place until drying. The inks generally comprise an aqueous solvent, which can further comprise an alcohol and/or other organic solvent in some embodiments, although other solvents can be effectively used if desired as long as there are soluble metal salts. The inks can further comprise dissolved metal compositions as a metal source for the fusing process. Without wanting to be limited by theory, it is believed that components of the ink, e.g., alcohol, or other organic compositions such as polymeric polyhydroxyl compositions, reduce the metal ions from solution to drive the fusing process. Previous experience with the fusing process in these systems suggests that the metal preferentially deposits at the junctions between adjacent metal nanowires. A polymer binder can be provided to stabilize the film and to influence ink properties. The particular formulation of the ink can be adjusted to select ink properties suitable for a particular deposition approach and with specific coating properties on a substrate surface. Drying conditions can be selected to effectively perform the fusing process.

The nanoparticle inks for forming a fused metal nanostructured network generally comprise an aqueous solvent, metal nanowires, metal ions, a polyhydroxyl polymer binder, and optional wetting agent or other process aids. The aqueous solvent can further comprise an alcohol, such as ethanol or isopropyl alcohol, and/or other organic solvent in some embodiments. Metal ions, as a source of metal for the fusing process, can be supplied as a soluble metal salt. The metal nanowire ink can include from about 0.01 wt % to about 1 wt % metal nanowires, from about 0.02 wt % to about 5 wt % polymer binder, from about 0.001 wt % to about 1 wt % wetting agent/surfactant and/or other processing aid, and silver ions or other metal ions for fusing in a concentration from about 0.01 mg/mL to about 2.0 mg/mL. A person of ordinary skill in the art will recognize that additional composition ranges within the explicit ranges above are contemplated and are within the present disclosure. Suitable silver salts to obtain sufficient solubility include, for example, silver tetrafluoroborate (AgBF₄), silver hexafluorophosphate (AgPF₆), silver perchlorate (AgClO₄), silver hexafluoroantimonate (AgSbF₆), silver trifluoroacetate (AgCF₃COO), silver heptafluorobutyrate (AgC₄F₇O₂), silver methylsulfonate (AgCH₃SO₃), silver tolylsulfonate (AgCH₃C₆H₄SO₃), or mixtures thereof. Suitable palladium salts are mentioned above. Other metal salts include, for example, salts soluble in the aqueous solvent and reducible under the process conditions. Various surfactants can be used in principle, and fluorosurfactants have found popularity due to various pragmatic reasons. Alcohols can serve both as solvents and as wetting agent to form good coatings at higher concentration.

Within reasonable ranges, the amount of solvent in the nanowire ink can be adjusted to change the solids concentration and associated rheology of the ink. For making transparent conductive film s for high optical quality applications, such as touch sensors for smart devices, the inks are generally applied using a slot-die coating technique onto a polymer film, which can be practiced in a roll-to-roll format. Similar approaches can be used for making the heater elements. As with touch sensor formation, the resulting coated film can then be laminated or applied with an adhesive film into a further layered structure. The slot coating can also be directly applied to a specific piece for assembly into the heater structure. Also, for larger area coverage (such as greater than a square millimeter), spray coating can be used. While in principle, ink jet printing can be used with nanowire inks, from a practical perspective, usual ink jet resolution has been elusive due to clogging if the nozzle is too narrow. But for larger area coating, spray coating or ink jet coating can be achieved using a larger nozzle that would not be prone to clogging due to nanowire morphology. Screen printing has been described for metal nanowire inks, but resolution has generally not been at a desirable value for most applications. See, Li et al, “Screen printing of silver nanowires; balancing conductivity with transparency while maintaining flexibility and stretchability”, Nature Flexible Electronics (2019) 3:13; https://doi.org/10.1038/s41528-019-0057-1, incorporated herein by reference.

After coating, the solvent is removed by evaporation. Fusing occurs during the drying process. Heat can be applied to facilitate solvent removal and help to drive the fusing process. As noted above, room temperature fusing can be used with proper selection of ink and process conditions. See the '552 application cited above. While heat can be applied as appropriate for a particular process framework, blowing warm air, passage through an oven, use of a heat lamp, combinations thereof, or the like can be appropriate. Once the conductive film is dry, additional processing can take place.

Patterning of transparent conductive films for touch sensor applications is generally performed using laser ablation or photolithography with etching. In some embodiments, the transparent structure has an unpatterned area of at least about 0.25 cm². For heater applications, patterning is generally not needed or can be performed with low resolution consistent with macroscopic structures. For heater applications, patterning may not be used since for heat generation, heating is desired across the whole heater surface. However, some etching of the conductive material can be desirable to improve heat generation uniformity. This adjustment of the heater surface can be particularly useful for non-rectangular heater shapes.

A method for making a transparent conductive heater on a precursor surface may comprise forming a coating of metal nanowires from a solution onto a surface, drying the nanowire coating to form a transparent conductive film comprising a sparse metal conductive layer, and forming conductive electrodes establishing electrical connections to the transparent conductive film with a circuit path along the transparent conductive film between two electrodes forming a heater surface with significant surface power density generated across the heater surface from an applied voltage between the electrodes.

The surface may be a non-planar transparent surface designed for exposure to an ambient environment, and further comprising applying a protective overcoat over the heater surface. The protective overcoat may be laminated in place with an optically clear adhesive or the overcoat may be formed by applying a liquid that is then cured. Transparent polymer barrier layers can be applied as liquids to form the protective coating. Insert molding or over molding can be used to form ta protective polymer cover consistent with either first applying the transparent conductive layer to the device surface, direct coating, or with forming a transparent conductive layer onto a polymer substrate that is then secured to the surface during the molding process. Insert molding of transparent materials is described generally in published PCT application, WO2022/138052 to Okuda et al., entitle “Decorative Film for Insert Formation, Method of Decorative Film for Insert Formation, and Manufacture Method for Resin Molded Prouct,” incorporated herein by reference. The transparent conductive surface may be on a polymer sheet coated in a roll-to-roll process and further comprising laminating a section of the coated polymer sheet after forming the electrodes to a transparent device surface to be heated.

A method for making a transparent conductive heater on a non-planer precursor surface may comprise laminating a flexible polymer substrate with a sparse metal conductive layer, forming a nanowire based transparent conductive heater surface, onto a non-planar transparent surface with the heater surface oriented toward the transparent non-planar surface to form a heated transparent structure. The sparse metal conductive layer may be formed using solution coating of a precursor ink in a roll-to-roll process onto the flexible polymer substrate. The precursor ink may comprise metal nanowires and metal ions and wherein drying of the coated precursor solution results in the formation of a fused metal nanostructured network.

The method may further comprise printing electrodes at selected locations for heaters structures using silver conductive paste, and/or cutting the flexible polymer substrate to obtain a heater structure with a heater surface framed by the electrodes. Conductive silver pastes are available commercially from DuPont, Shanghai Daejao Electronic Materials, Hunan National Silver New Materials, BLT, NanoTOP, Eisho, Shanghai Silver paste, Junyng Electronic, Nanometal Technology, Resink, Soltrium, Shanghai Sunsen Electronic Materials, and Shanren New Materials. The heater structure may be laminated to a device surface optionally using an optically clear adhesive.

### Electrical Properties and Heat Generation

For heater applications, the electrical conduction/resistance is used for the generation of heat, so the current flow is selected to provide desired heat generation in response to an applied voltage. In principle, the resistivity can be considered with mathematical precision, although that would be an illusion since it ignores atomic level structure and even more importantly the collective nature of the material properties that are inherently on a coarser scale. Nevertheless, Maxwell's equations can be solved numerically over the heater element with some degree of resolution with boundary conditions set by the voltage at the electrodes and the resistivity along the heater element. This would provide values of current flow across the heater, which can then be used to evaluate power density. While this modeling can be done, reasonable approximations can be used to significantly simplify the calculations, such as use of a reasonable grid size. Approximations can be performed for any heater shape and electrode configuration. From a practical perspective, heat also flows and does not remain localized, so the heat generated as a result of the resistivity is further blurred in a practical sense. To guide patterning of the heating surface, some reasonable use of a grid and approximations can provide sufficient practical guidance.

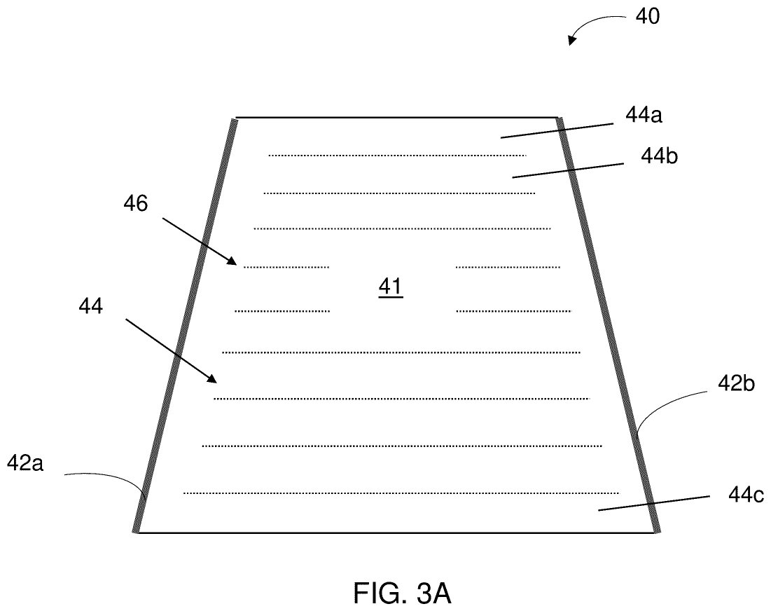

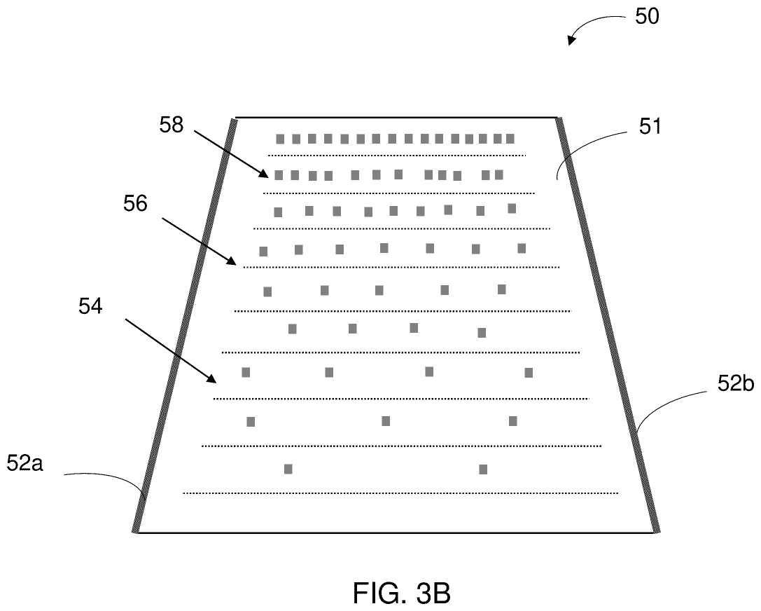

For heaters with an appropriate configuration, one reasonable approximation has the current flowing directly between the electrodes. For rectangular oriented electrodes, this current flow reflects the geometry, neglecting edge effects. For trapezoidal positioned electrodes with equal length electrodes having a shorter length connecting one end of the electrodes and a longer length connecting the other end of the electrodes, stripes can be contemplated as conceptually dividing the heater surface into zones, with one example depicted in FIG. 3A. Trapezoid shaped heater 40 comprises conductive layer 41 between nonparallel metal traces 42a and 42b with conceptual or actual etched horizontal lines 46 extending across the conductive layer dividing the layer into zones 44 such as zones 44a-44c. An approximation would be to assume that the current in each stripe (one zone) is constant and lateral between the electrodes. In the limit of ever thinner stripes, this would become exact, subject to the approximation of the current flow direction and the blurring required to define the relevant parameters, which are not atomic scale values. Within each stripe, the length L between electrodes can be considered an average, so basically the length at the center of the stripe. With these approximations, the power density can be approximated for each stripe.

With the approximations specified in the previous paragraph, the powder density for a stripe is P_{d}(i)=V²/(Rₛ(i)·L(i)²), where “i” is the indication for the particular stripe or zone. With a constant voltage V along the electrodes, as the length changes, the resistivity should correspondingly change in the inverse ratio to maintain the surface power density approximately constant. Alternatively, the voltage can be changed, optionally while keeping the sheet resistance approximately constant, which is described further below. It should be kept in mind that parameters can be considered with reasonable granularity, which is appropriate due to thermal conduction and other reasonable factors, and that more mathematical precision can be achieved if numerical modeling were considered desirable.

With respect to altering the resistivity along the heater surface, this can be done with altering the conductive elements in one or more of three ways: 1) non-uniform deposition, 2) etching of some conductive material, and/or 3) selectively damaging the conductive material.

With respect to non-uniform deposition, the deposition of additional silver nanowires correlates with a lower resistivity, and conversely, the deposition of lesser amount of silver nanowires correlates with greater resistivity. Thus, non-uniform deposition can be designed to have a reduced loading of silver nanowires at regions of small L to increase the resistivity in these regions to aim for a more constant value of the product of p(i) and L(i). The distribution pattern can depend on the deposition approach. Coating methods generally are designed for uniform deposition, but modifications are possible especially for lower resolution variations. While printing approaches are complicated for nanowires due to the aspect ratio, spray coating through a larger nozzle can be performed, and spray coating can be varied as the spray nozzle is moved across the heater area.

Etching has been used for patterning transparent conductive films for forming touch sensors and the like. The objective for this heater etching is different since the objective is to increase sheet resistance and not necessarily to control direction of current flow, but etching can form areas of essentially infinite resistivity, which alters the overall resistivity in some granular consideration of the resistivity between the opposite polarity electrodes. Due to these differences, the amount of etched material is generally less for the heater applications. For the sake of clarity, in this context, “removal” refers not only to physical removal but also to electrical isolation from the conductive pathway even if not completely physically removed. Etching can be performed with a laser or other focused radiation that ablates the conductive film from the substrate surface, which may also electrically isolate domains to remove them from the conduction pathway. Additionally or alternatively, etching can be performed by lithography and chemical, plasma or vapor etching through a temporary mask. Etching should substantially maintain current flow between the electrodes with the aim of improved uniformity of surface power density.

Laser etching along thin lines between the electrodes is exemplified, as described below. In alternative embodiment, etching can be performed using lithography and an etchant material, fluid, vapor, plasma, or combination thereof, and such approaches have been used for sensor formation. The main effect of this etching is to reduce the current carrying area to make a small zone of no power generation. The objective is when looking more granularly as the power generation, this can be more uniform of a zone of power generation is removed at a region of greater power output, such that the observed surface power density is more uniform on the granular level. The design of the etching can be selected to achieve a more uniform surface power density. With this objective in focus, any etched zone should be small in size relative to the length of thermal conduction so that the lack of power generation from an etch region does not significantly influence the observed surface power density. With these constraints in mind, other etching patterns can be used. For example, a pattern of spots, which can be formed using laser etching or lithography, can effectively increase resistivity on a granular level by introducing small local areas of effectively infinite resistivity. More etched points can be introduced in regions at which the surface power density is desired for reduction. This patterning of etched spots can, in principle, be effective at improving the uniformity of the surface power density with an appropriately distributed etch pattern. A schematic view of a patterning with etched spots is shown in FIG. 3B. FIG. 3B is a schematic top down view of trapezoid shaped heater 50 comprising conductive film 51 between nonparallel metal traces 52a and 52b with conceptual horizontal lines 56 extending across the conductive layer dividing the layer into zones 54. Conductive film 51 is etched with spots 58. With the objective of more uniform surface power density, the smallest dimension of an etched feature, such as diameter of a circular zone or width of a line, should generally be small relative to lengths of thermal conduction, such that any thermal gradients are small. While suitable dimensions generally depend on the materials, these dimensions can generally be a millimeter of less and in some embodiments can be 5 microns to 500 microns. A person of ordinary skill in the art will recognize that additional ranges within these explicit ranges if dimensions are contemplated and are within the present disclosure.

In one model for patterning etched spots can be based on the above idea of conceptual stripes with approximate uniform current. As a crude approximation, one can assume that the change in sheet resistance along a stripe is approximately Rₛ₀ SAₙ/SA, where Rₛ₀ is the sheet resistance of the unetched material, SA is the surface area of the stripe and SAₙ is the surface area adjusted for the surface area lost to etching. This assumes a linear relationship with respect to the surface area of the resistive material and its conductivity properties. Empirical corrections can be made to correct for errors in this approximation. This suggestion should provide a reasonable starting point. Each of the conceptual stripes can be adjusted with etched spots to achieve a roughly constant surface power density based on the proportion of conductor removed. This simple model does not account for any pattern of the spots, but spacing the etched spots spread out generally away from each other would be appropriate to avoid interference of the etched spots with each other. While etched stripes and etched spots would seem to offer relatively simple process approaches, other etched shapes can be used as desired.

The third approach directed to damaging the transparent conductive layer to alter the resistivity can be applied over a large portion or all of the area of the transparent conductive film or in a smaller pattern similar to the etching, and the degree of damage can be adjusted accordingly to achieve the objective of more uniform surface power density. For example, a strong acid can be used to damage the conductive layer. At higher concentrations, a strong acid can be highly damaging so applied in a pattern, the damage can be qualitatively similar to the etching process described above. At lower concentrations, the strong acid can be less damaging, and the concentrations can be varied at different locations along the heater surface to provide a more consistent surface power density. The degree of damage can be empirically adjusted to yield a sheet resistance along a stripe Rₛ(i) to compensate for the change of length along the stripe to yield a less varying surface power density.

As noted above, a bus bar/electrode can be divided to provide for application of different voltages along the heater surface to provide more uniform surface power density. In this situation, the surface power density can be written as P_{d}=V(i)²/(Rₛ L²), where V(i) is the voltage along a stripe. To provide a current flow across the heater with less current flow vertically as depicted in FIG. 3B, it may be desirable to etch gaps between the stripes at different voltages. The gaps between the electrode/bus bar segments can be from 5 microns to 500 microns, and similarly, etched gaps in the conductive layer between adjacent stripes can be from 5 microns to 500 microns. Such a design would combine features from FIG. 2C and FIG. 3B. The changes in voltage can roughly correspond to the changes in length (e.g., average for a stripe), so if the length gets smaller, the voltage can be adjusted to be smaller by the same percentage. Generally, the number of divided bus bar segments can be at least three, in some embodiments, 4, 5, 6, 7, 8, 9, 10, 15, 20 or more than 20 or from 3 to 20. A person of ordinary skill in the art will recognize that additional ranges of segment numbers within the explicit ranges above are contemplated and are within the present disclosure. A power supply correspondingly supplies the selected voltage to the bus bar/electrode segment either using an appropriate voltage converter, such as a transformer for ac power, a DC-DC converter or other appropriate circuit.

As noted above, the current can be modeled numerically, but the approximate structures should adequately guide device design. It is assumed that the temperature dependence of the resistivity is negligible over the relevant temperature ranges. Empirical measurements can be useful for adjusting device design to achieve desired thermal properties of the heater for actual use. Desired optical properties and visual appearance can also influence device design. Increasing resistivity generally involves increasing transmittance, all else being equal, either due to less metal deposited or etching. If more uniform transmittance is desired, there can be ways to transmittance from some regions by tinting or various other routine ways, although it is not as easy to increase the transmittance for regions with relatively lower transmittance due to lower resistivity. Also, visibility of patterns may provide esthetic incentives to select some embodiments for improving surface power density over other approaches.

### Device Structures

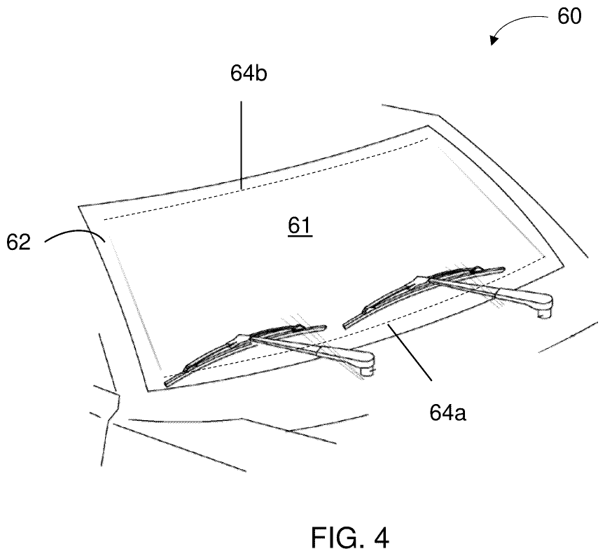

The heaters are generally desired to be incorporated into a transparent structure. With the range of structures that can effectively use the heater, the nature of the transparency may be distinct from optical properties associated with, for example, a display or the like. For example, the structure may be transparent in only a portion of the spectrum. A machine vision device may need transparency in the infrared, but not necessarily in the visible. As another example, car windows may be tinted to limit glare. Some systems are designed to block UV light. In any case, the structure with the heater generally has a transmittance over a useful spectral range from the infrared to the visible at is at least about 70%. For imaging systems operating in the infrared, the relevant spectral region can be from 750 nm to 1750 nm or a selected portion thereof. For optical systems used for human vision, such as a vehicle window, the transmittance over all or a significant portion of the visible spectrum (which can be set from 400 nm to 750 nm or a different range if desired) is at least about 70%, although in some embodiments it can be significantly more transparent, such as a transmittance of at least about 80% and in further embodiments at least about 90% over the desired region of the spectrum. A representative set of transmittance measurements are presented in FIG. 1 for transparent silver nanowire films formed with a sheet resistance of 30-50 Ohms/sq on either a polyethylene terephthalate optical film or a polycarbonate optical film. Over most of the relevant wavelength range, the transmittance with the substrate is >90% and corresponding values with the substrate transmittance removed would result in transmittance values just for the conductive layer of >95%. FIG. 4 is a schematic illustration of portion 60 of a vehicle with windshield 62 configured with transparent conductive film 61 and supporting bus bars 64a and 64b.

The transmittance through the structure incorporating the heater generally comprise transparent structures on both sides of the heater element itself, and the overall transmittance involves the cumulative effect of the structural elements including the heater element itself. The transmittance of the heater element correlates with electrical resistance due to an increase in silver loading generally lowers transmittance and decreases resistance. Thus, if lower transmittance is needed, the electrical resistance can be lowered if desired. Generally, the heater element layer can have a sheet resistance from about 250 Ohms/sq to about 1 Ohm/sq and a visible light or infrared light transmittance from about 80% to about 99.5%. A person of ordinary skill in the art will recognize that additional ranges of sheet resistance and transmittance within the explicit ranges above are contemplated and are in the present disclosure.

To the extent that the device is a window that is part of another structure, such as a vehicle and/or a sensing device, there is still generally a concept of an interior surface and an exterior surface. If the heater structure is directly mounted on a device component, the mounting surface may be integral to a device where the interior surface is another layer of the device. But in any case, the heater is generally mounted on a surface that is oriented in some sense to an exterior surface, which generally is expected to experience environmental issue, such as cold temperatures and/or precipitation, such as fog, rain, snow, ice, combinations thereof and the like. The heater structure needs protection from environmental assaults but correspondingly needs to provide heat to the exterior of the protective layers that directly experience the environmental assaults. The different purposes of these protective materials should be correspondingly balanced.

Depending on the process, the structure can be built up sequentially or assembled from components that are separately assembled for combining, or some combination of these approaches. Layers of optically clear adhesives can be used as appropriate. If the transparent conductive film is formed on a sheet or roll of substrate for assembly onto the device, a particular assembly order follows. Regardless of the procedure, the final structure generally has a transparent interior layer, the transparent conductive film forming the heater structure, optional overcoat and/or undercoat, a transparent protective exterior layer and one or more optically clear adhesives.

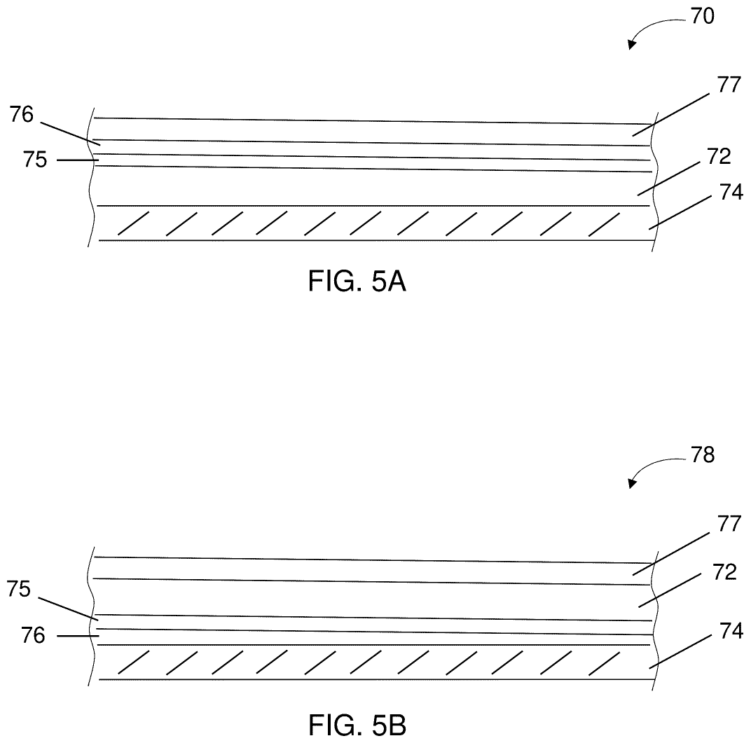

FIGS. 5A and 5B give schematic cross-sectional views of example embodiments showing layered structures. FIG. 5A shows layered structure 70 comprising conductive film 72 disposed between substrate 74 and optional overcoat 75. Optical adhesive layer 76 adheres protective layer 77 to optional overcoat 75 or to conductive film 72 if the overcoat is not present. FIG. 5B shows layered structure 78 comprising conductive film 72 disposed between optical adhesive layer 76 and protective layer 77. Optional overcoat 75 is disposed between conductive film 72 and optical adhesive layer 76. Optical adhesive layer 76 adheres optional overcoat 75 to substrate 74, or conductive film 72 to substrate 74 if the overcoat is not present. Embodiments comprising layered structures are not limited to those shown in FIGS. 5A and 5B. In general, coatings and/or layers such as undercoats, hardcoats, adhesive layers, protective films and substrates may be used in various configurations to form layered structures, and in some configurations, all of the layers may not be used.

In some embodiments, the sparse metal conductive layers can be covered with a polymer overcoat to provide mechanical protection to the conductive layer, especially during the production process. If useful for improved adhesion, a similar undercoat can be used to form a surface for deposit of the transparent conductive film that forms the heater structure. The terms overcoat and undercoat refer to layers relative to the deposition processes and not to the orientation in the ultimate device. An overcoat or an undercoat generally has a thickness of no more than about 250 nm, for example, from about 5 nm to about 200 nm. Suitable hardcoat polymers for use in forming the overcoat are generally highly crosslinked polymers with crosslinked polyacrylates that can be combined with other crosslinked moieties, such as polyurethanes, epoxy polymers, polysiloxanes and/or other crosslinked polymers. In some embodiments, it may be possible to select an overcoat such that after application of the overcoat, the haze is significantly reduced without significantly degrading other properties. Also, the thickness and compositions of the overcoat can be selected such that the sheet resistance measurement through the overcoat is not significantly altered relative to the measurement without the overcoat. The incorporation of additional stabilizers into coatings is described further below and in published U.S. patent application 2018/0105704 to Yang et al. (hereinafter the '704 application), entitled “Stabilized Sparse Metal Conductive Films and Solutions for Delivery of Stabilizing Compounds,” incorporated herein by reference. The incorporation of silver ions or other noble ions for providing stabilized or improved fusing of the fused metal nanostructured network is described in published U.S. patent application 2021/0151216 to Yang et al., entitled “Coatings and Processing of Transparent Conductive Films for Stabilization of Sparse Metal Conductive Layers,” incorporated herein by reference.

Depending on the use of the overcoat or undercoat, more generally, suitable overcoat polymers include, for example, polyethylene terephthalate (PET), polyethylene naphthalate (PEN), polyacrylate, poly(methyl methacrylate), polyolefin, epoxy, polyvinyl chloride, fluoropolymers, polyamide, polyimide, polysulfone, polysiloxane, polyetheretherketone, polyethersulfone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Overcoat polymers can be applied by solution coating with optional subsequent crosslinking, such as by UV light exposure. Overcoat and undercoat polymers can be applied using the same techniques as the nanowire inks. More generally, the overcoat can have an average thickness from about 5 nm to about 2 microns, in further embodiments from about 7 nm to about 1 micron, and in other embodiments from about 8 nm to about 250 nm. A person of ordinary skill in the art will recognize that additional ranges of overcoat thicknesses within the explicit ranges above are contemplated and are within the present disclosure.

Overcoats and/or undercoats can comprise stabilization compounds that can help to prolong good electrical conduction with exposure to environmental assaults. Previous work has found that vanadium (+5) compounds can be effective to provide desired stability. See published U.S. patent application 2018/0105704 to Yang et al. (hereinafter the '704 application), entitled “Stabilized Sparse Metal Conductive Films and Solutions for Delivery of Stabilizing Compounds,” incorporated herein by reference. Others have found that iron (+2) and other metal salts can be effective stabilizers, see published U.S. patent application 2015/0270024A1, to Allemand entitled “Light Stability of Nanowire-Based Transparent Conductors,” incorporated herein by reference. Also, cobalt (+2) ions complexed with ligands have been found to provide stabilization within a fused metal nanostructured network layer. The performance of these stabilization compositions alone or combined, can be enhanced through incorporation of noble metal ions, especially, silver ions within a coating (overcoat and/or undercoat) to further enhance the stability, possibly due to further fusing of the structure with migration of the metal ions. The benefits of the noble metal ions in a coating can be exploited similarly to the pentavalent vanadium during actual use of the structure in a product, although alternatively or additionally it may be beneficial to have the noble metal ions in the coating during a post deposition heat/humidity processing prior to assembly into a final product.

Suitable vanadium +5 compounds include compounds with the vanadium as a cation as well as compounds with vanadium as a part of a multi-atom anion, such as metavanadate (VO₃) or orthovanadate (VO₄⁻³). Corresponding salt compounds with pentavalent vanadium anions in an oxometalate include, for example, ammonium metavanadate (NH₄VO₃), potassium metavanadate (KVO₃), tetrabutylammonium vanadate (NBu₄VO₃), sodium metavanadate (NaVO₃), sodium orthovanadate (NasVO₄), other metal salts and the like, or mixtures thereof. Suitable penta-valent vanadium cation compounds include, for example, vanadium oxytrialkoxides (VO(OR)₃, R is an alkyl group, for example, n-propyl, isopropyl, ethyl, n-butyl, or the like, or combinations thereof), vanadium oxytrihalides (VOX₃ where X is Cl, F, Br or combinations thereof), vanadium complexes, such as VO₂Z₁Z₂, where Z₁ and Z₂ are independently ligands such as those described further below with respect to Co+2 complexes, or combinations thereof. In coatings, the penta-valent vanadium can be present, for example, from about 0.01 wt % to about 9 wt %, in further embodiments, from about 0.02 wt % to about 8 wt % and in additional embodiments from about 0.05 wt % to about 7.5 wt %. In a coating solution, the solution generally comprises some solvent along with the solids that primarily comprise a curable polymer. Generally, the corresponding coating solution can have the penta-valent vanadium compounds in concentrations from about 0.0001 wt % to about 1 wt %. A person of ordinary skill in the art will recognize that additional ranges of concentrations within the explicit ranges above are contemplated and are within the present disclosure. In additional or alternative embodiments, iron (+2) or other metal ions can be included in addition to or alternatively to the pentavalent vanadium ions.

While the overcoat is thin, it may still be desirable to facilitate thermal conduction through the overcoat. Nanoparticles of a high thermal conducting material can be added to the overcoat to improve thermal conductivity consistent with maintaining the transparency. Suitable high thermal conductivity material can be selected from the group consisting of diamond, graphene, silicon nitride, boron nitride, aluminum nitride, gallium arsenide, indium phosphide or a mixture thereof. High thermal conductivity materials can have a thermal conductivity of at least about 30 W/(m·K). Some of the high thermal conductivity nanoparticles may also provide abrasion resistance as an added benefit. In some embodiments, the nanoparticles can have an average primary particle diameter of no more than about 100 nm. The transparent coatings formed from the nanoparticle loaded polymers can comprise from about 0.01 weight percent (wt %) to about 70 wt % property enhancing nanoparticles, in further embodiments from about 0.05 wt % to about 60 wt %, in other embodiments from about 0.1 wt % to about 50 wt %, and in additional embodiments from about 0.2 wt % to about 40 wt % property enhancing nanoparticles. The transparent coatings can further comprise polymer binder, optional property modifiers, such as crosslinking agents, wetting agents, viscosity modifiers, and/or stabilizers, such as antioxidants and/or UV stabilizers. A person of ordinary skill in the art will recognize that additional ranges of average particle diameter and nanoparticle concentrations in the loaded polymers within the explicit ranges above are contemplated and are within the present disclosure. The use of property enhancing nanoparticles in optically clear overcoats is described further in U.S. Pat. No. 10,738,212 to Virkar et al., entitled “Property Enhancing Fillers for Transparent Coatings, and Transparent Conductive Films,” incorporated herein by reference.

Depending on the particular use, the underlying structure supporting the heater can take various forms, but the underlying structure generally provide a rigid foundation even if not flat. Thus, for example the underlying structure can be, for example, a car window. The underlying structure can have multiple layers, independently individually with or without patterning. In any case, a protective layer covers the transparent conductive film forming the heater surface to protect the heater. The protective layer should provide its protective function, but a specific selection can be influenced by the nature of the underlying structure, such as due to the shape and/or rigidity.

In some embodiments, the ultimate structure has a transparent protective layer comprising a polymer and/or glass, in one or a plurality of layers. Suitable polymers can comprise hardcoat polymers as described above or layers of material such as with a hardcoat top surface for abrasion resistance. To provide desirable performance of the heater with respect to providing heat to the surface of structure, it can be desirable for the transparent protective layer and an overcoat layer to provide good thermal conductivity. As noted above, Applicant has described the incorporation of desirable nanostructures to modify the properties of transparent coatings. In particular, high thermal conductive nanoparticulate additives can be incorporated, such as nanodiamond, graphene, silicon nitride, boron nitride, aluminum nitride, gallium arsenide, indium phosphide or a mixture thereof. To provide good transparency, the additive particles generally have an average particle size of no more than about 100 nm. These thermally conductive nanoparticles can be incorporated into other protective layers of the device structure in addition to the overcoat layer. The loading concentration of thermally conductive additives can be selected to balance the mechanical, optical and thermal properties of the protective material. Thermally conductive glass is also known, see for example, published Japanese patent application 2012111665A to Atsuo et al., entitled “Heat Conductive Glass, and Method for Manufacturing Same.” incorporated herein by reference.

While the structures of interest are transparent, the transmittance may not need to be extremely high, depending on the particular application. So a transmittance of greater than 75% may be suitable, and perhaps less for some applications. Hardcoat protective layers can be adapted form other automotive uses, such as hardcoats for headlights or the like. The hardcoat polymers generally are at least about 2 microns thick, in some embodiments at least about 4 microns thick and in further embodiments from about 5 microns to about 250 microns thick. One example of a hardcoat for car headlights is described in published U.S. patent application 2011/0003142 to Asuka et al. (hereinafter the '142 application), entitled “Nanoparticle Sol-Gel Composite Hybrid Transparent Coating Materials,” incorporated herein by reference. The '142 application discusses inclusion of nanoparticles including silicon nitride, and can include other thermal conductive nanoparticles. Also, the materials of the '142 application are silicates, which should provide good thermal conductivity. Processing of the structure should not involve excessive heat, which can damage the heating element. Acceptable temperatures can depend on how long the temperatures are applied for. The '142 application discusses embodiments using a catalyst to allow for processing of the coating below 100° C., which would be suitable for the heating elements for a reasonable period of time.

As noted above, the device resistance depends on the sheet resistance of the heating element and the configuration of the heater electrodes. In particular, current flows between the two electrode poles. The bus bars are generally not transparent even though the heater element is transparent. It may be desirable to locate the bus bars within the frame of the device to hide them from view, but this may tend to result in the electrodes formed by the bus bars being further away from each other than other placements, and the larger distance tends to result in a higher resistance, as noted above. If the resistance is sufficiently low nevertheless and/or the voltage can be adjusted high enough, a desired power output may be achieved with bus bars placed in the device frame. In alternative or additional embodiments, the bus bars can be placed within the field of view if they are not excessively blocking the view to result in a lower resistance and a higher power output for the available voltage. Based on the description above and as shown in the Examples, the adjacent placement of a plurality of electrode pairs in an effective parallel placement may not significantly alter the performance assuming the bus bars can be assumed to have negligible resistance. The distance between bus bars of opposite polarity influences the resistance and can help to lower the resistance. And additional electrode pairs can be used as desired to cover a larger area. The Examples also describe non-rectangular heater surfaces, such as electrode placement to form a trapezoid shape for the heater area.

### EXAMPLES

The Examples describe heating performance of transparent thin layers of conductive coating based on platinum coated silver nanowires on a polymeric substrate. Parameters contributing to particular power output from the heaters are discussed as well as failure limits. Comparison of heating performance for platinum coated versus uncoated silver nanowires is also described.

### General Materials and Methods

Silver nanowires (Ag NW) were available in a formulation as ActiveGrid® GEN5 Inks obtained from Applicant C3Nano, Inc. The silver nanowires have an average diameter of about 20-22 nm and were prepared as described in the '230 patent cited above. Platinum coated silver nanowires (Ag@Pt) were prepared by coating Ag NW with platinum using the direct deposition method described in the '534 patent cited above. The platinum coating may comprise approximately one or a few monolayers of platinum on the silver nanowires.

An ink comprising the platinum coated silver nanowires was prepared by combining the nanowires at a level between 0.1 wt % to 1.0 wt % and a cellulose based binder between 0.01 wt % to 1 wt %, a fluoro-surfactant between 0.002 wt % to 0.01 wt %, and a silver salt between 0.005 wt % to 0.1 wt % in water and a small amount of alcohol. The ink was slot coated at different thicknesses onto polyethylene terephthalate (PET) substrate having a thickness of 125 microns, although some coating was performed on 175 micron polycarbonate. The films were dried by heating in an oven at 100° C. for 10 minutes. Average sheet resistance was measured using a contactless measurement device from SURAGUS GmbH.

Each coated sample was cut into sections and silver paste obtained from BTL CHME LLC was painted on the coated side of the samples to define a multidimensional rectangle, followed by annealing at roughly 130° C. for 30 minutes to cure and dry the silver paste. Trace designs and their evaluation are discussed in the context of the following examples. Wire leads were connected to the silver paste as indicated in each of the trace designs and circuit resistance based on trace design and transparent conductor conduction was measured using a commercially available multimeter.

To evaluate heating uniformity across the transparent conductor, thermal images were obtained using a FLIR thermal imaging camera from MoviTHERM Co.

### Example 1

This example was performed to compare relative stability of films formed with platinum coated silver nanowires and comparable silver nanowires free of metal coating. Inks prepared with the nanowires were separately coated on 125 micron PET, and coating thicknesses were selected accordingly. Three coated films of the platinum coated nanowires and two coated films of silver nanowires free of metal coating were prepared to provide a range of sheet resistances. Results are shown in Table 1.

TABLE 1

| | Sheet Resistance |
|---|---|
| Sample | (Ohms/sq) |
| Ag@Pt-100 | 100 |
| Ag@Pt-100 | 130 |
| Ag@Pt-100 | 200 |
| Ag-90 | 90 |
| Ag-190 | 190 |

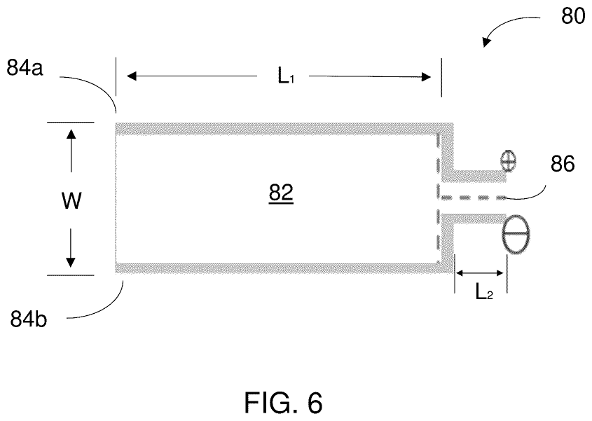

Each coated sample shown in Table 1 was configured for testing using the trace design shown in FIG. 6. Trace design 80 shows silver paste traces 84a and 84b, each having a width of 2 mm, defining area 82 of the coated sample. Each coated sample had length L₁=12.5 cm and width W=3.5 cm. The neck area of the design had length L₂=1 cm. Surface cut 86 was made between the traces as shown in dashed lines and leads were connected to define positive and negative terminals as shown in FIG. 6.

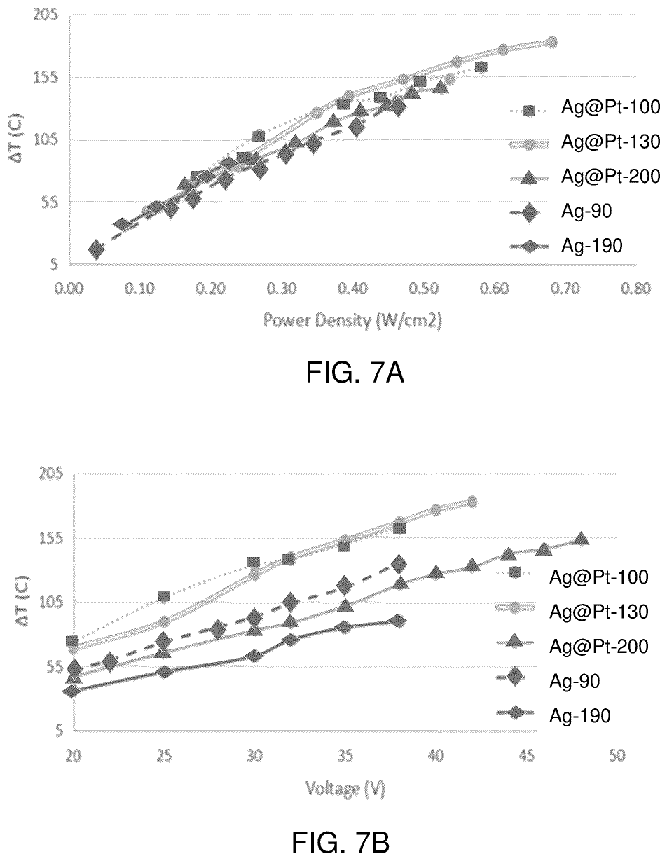

The heating performance for each of the configured samples was evaluated by measuring the change in temperature as a function of power density ranging between about 0.1 W/cm² to about 0.7 W/cm². The power density P_{d} can be calculated based on the formula P_{d}=(V²/R)/A, where V is the applied voltage, R is the measured circuit resistance, and A is the area of the heater element in selected units. A plot showing the change in temperature as a function of power density is shown in FIG. 7A. The data show the platinum coated silver nanowires exhibit improved thermal stability as compared to the uncoated silver nanowires. A plot showing the change in temperature as a function of voltage is shown in FIG. 7B.

### Example 2

This example was carried out in order to assess test design configurations including terminal isolation and trace thickness for evaluation of heating performance of transparent conductive coatings formed with the nanowire inks. This example also carried out measurements of temperature as a function of power density.

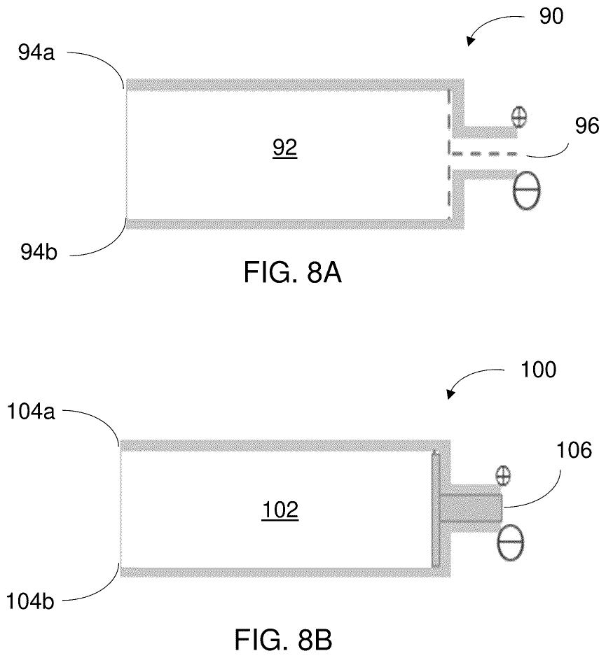

Each coated sample Ag@Pt-100, Ag@Pt-130 and Ag@Pt-200 was configured for testing using trace designs shown in FIGS. 8A and 8B, referred to as Methods A and B, respectively. Trace design 90 shows silver paste traces 94a and 94b defining area 92 of the coated sample. Surface cut 96 was made between the traces as shown in dashed lines and leads were connected to define positive and negative terminals as shown in FIG. 8A. Trace design 100 shows silver paste traces 104a and 104b defining area 102 of the coated sample. Area 106 (3.5 cm×12.5 cm with a 1 cm×1 cm neck area) was cut out between the traces and leads were connected to define positive and negative terminals as shown in FIG. 8B. Methods A and B were each evaluated using two different widths for the traces formed with the silver paste. One set included traces each having a width of 2 mm, and the other set included traces each having a width of 3 mm.

Methods A and B with the two trace widths were evaluated for each test sample by measuring circuit resistance. Results are shown in Table 2. The data suggest Methods A and B provide similar isolation between positive and negative terminals with little difference due to width of traces.

TABLE 2

| | Circuit Resistance (Ohms) | | | |
|---|---|---|---|---|
| | Method A | Method B | Method A | Method B |
| | 2 mm | 2 mm | 3 mm | 3 mm |
| Sample | width | width | width | width |
| Ag@Pt-100 | 44.1 | 43.2 | 39.1 | 41.5 |
| Ag@Pt-130 | 53.5 | 55.4 | 53.2 | 51.4 |
| Ag@Pt-200 | 73.6 | 72.9 | 67.3 | 67.3 |

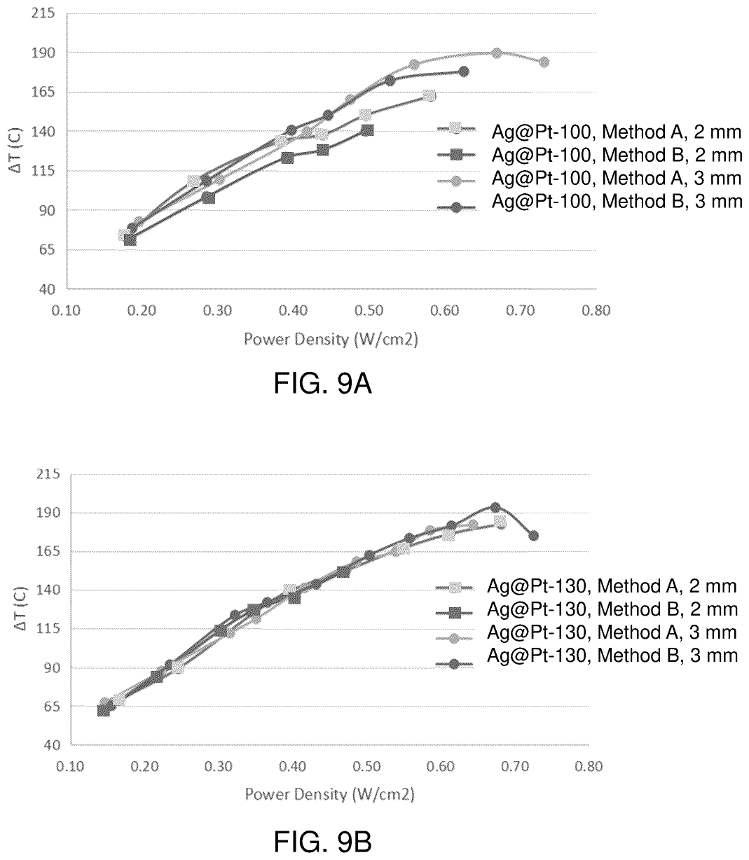

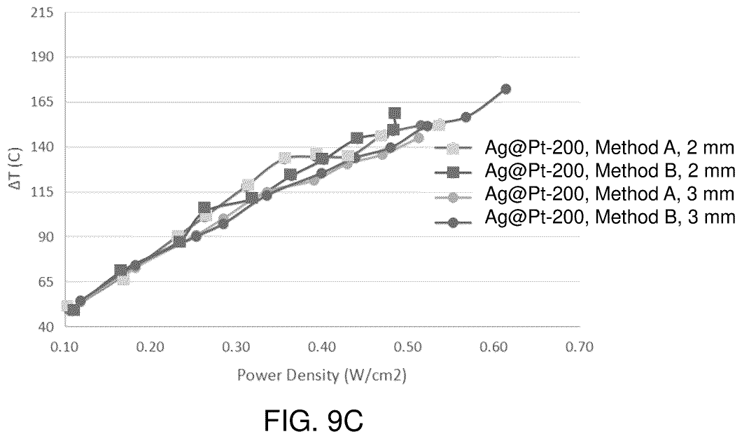

Heating performances of test samples Ag@Pt-100, Ag@Pt-130 and Ag@Pt-200 were evaluated by measuring the change in temperature as a function of power density ranging between about 0.1 W/cm² to about 0.8 W/cm². In the experiment, the voltage was gradually increased after the temperature stabilized until the sample failed to provide the values of the power density, and the temperature was measured near the center of the sample at each voltage. The power density Pa can be calculated as described above for Example 1. Plots showing change in temperature as a function of power density are shown in FIGS. 9A-9C. The data show little to no difference between Methods A and B, and for each of the methods, little to no difference due to change in width of the silver paste.

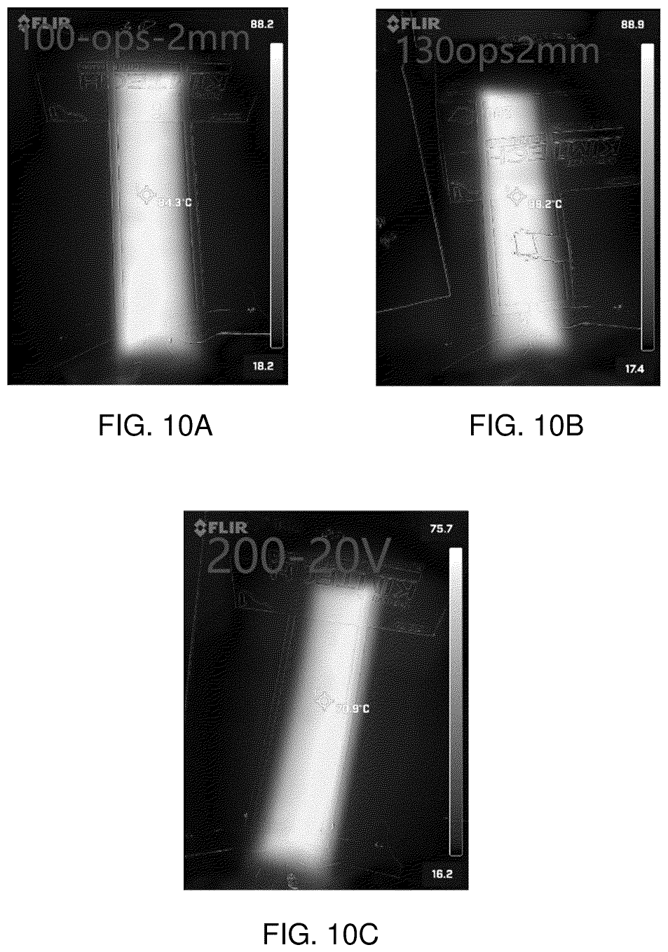

Thermal images are shown in FIGS. 10A-10C. The images suggest heating across the coating is uniform when heat is generated from a single side of the test sample with 2 mm width traces as shown in FIGS. 8A and 8B (Methods A and B, respectively). Temperatures were taken at approximate center location of the area being heated and results are shown in Table 3.

TABLE 3

| Sample | Temperature (° C.) |
|---|---|
| Ag@Pt-100 | 84.3 |
| Ag@Pt-130 | 88.2 |
| Ag@Pt-200 | 70.9 |

Failure voltages are shown in Table 4. The data suggest that the higher the resistance, the higher the voltage withstand performance.

TABLE 4

| | Failure Voltage (V) | | | |
|---|---|---|---|---|
| | Method A | Method B | Method A | Method B |
| | 2 mm | 2 mm | 3 mm | 3 mm |
| Sample | width | width | width | width |
| Ag@Pt-100 | 44.1 | 43.2 | 39.1 | 41.5 |
| Ag@Pt-130 | 53.5 | 55.4 | 53.2 | 51.4 |
| Ag@Pt-200 | 73.6 | 72.9 | 67.3 | 67.3 |

### Example 3

This example was carried out in order to assess test design configurations in which the coatings are supplied with current from opposing sides of a test sample as compared to providing current from one side as in described for Example 2.

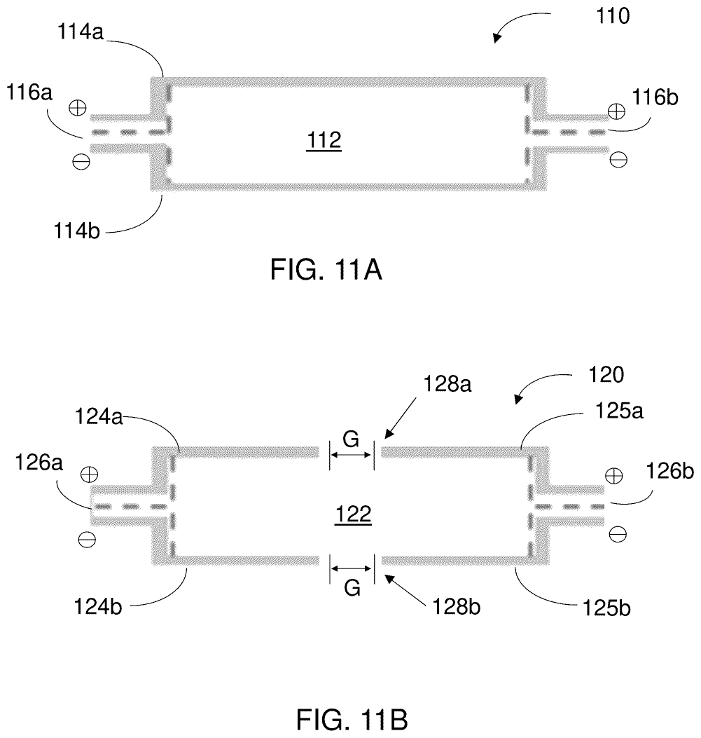

Coated samples Ag@Pt-130 and Ag@Pt-200 were configured for testing using trace designs shown in FIGS. 11A and 11B, referred to as Methods C and D, respectively. Trace design 110 shows silver paste traces 114a and 114b defining area 112 of the coated sample. Surface cuts 116a and 116b were made between the traces on opposing sides as shown and leads were connected to define two sets of positive and negative terminals as shown in FIG. 11A. Trace design 120 shows silver paste traces 124a, 124b, 125a and 125b defining area 122 of the coated sample. Gap 128a having separates traces 124a and 125a, and gap 128b separates traces 124b and 125b. Gap G for gaps 128a and 128b was approximately 1 mm. Leads were connected to the traces to define positive and negative terminals as shown in FIG. 11B. The width of silver paste traces was 2 mm.

Methods C and D were evaluated for Ag@Pt-130 and Ag@Pt-200 by measuring circuit resistance and results are shown in Table 5. The data suggest that the heating elements exhibit greater circuit resistance when evaluated using Method D with the 1 mm gap as compared to Method C.

TABLE 5

| | |
|---|---|
| Sheet | Circuit Resistance |
| Resistance | (Ohms) |

| Sample | (Ohms/sq) | Method C | Method D |
|---|---|---|---|
| Ag@Pt-130 | 130 | 60.2 | 63.7 |
| Ag@Pt-200 | 200 | 76.1 | 78.8 |

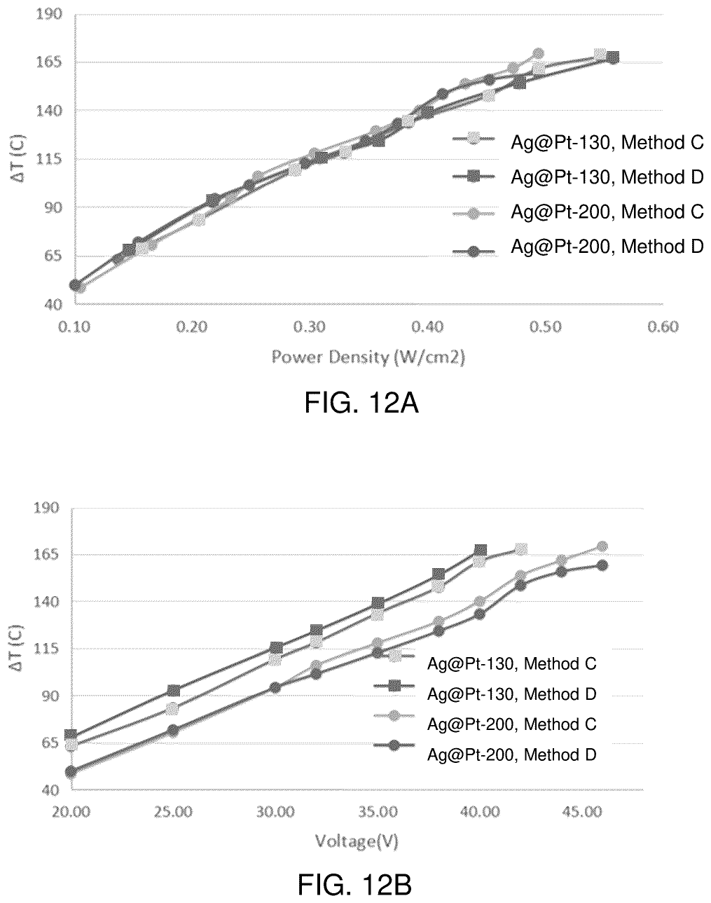

Heating performances of test samples Ag@Pt-130 and Ag@Pt-200 were evaluated by measuring the change in temperature as a function of power density ranging between about 0.1 W/cm² to about 0.8 W/cm². The power density Pa can be calculated as described above for Example 1. Plots showing change in temperature as a function of power density are shown in FIGS. 12A and 12B. As described above, the power density was changed by correspondingly changing the voltage. The data suggest Ag@Pt-130 and Ag@Pt-200 exhibit relatively stable performance using both Methods C and D.

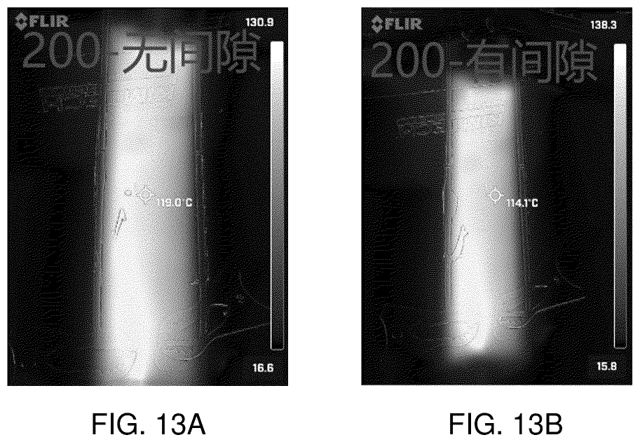

Thermal images of test sample Ag@Pt-200 evaluated using Methods C and D are shown in FIGS. 13A and 13B, respectively. The images suggest heating across the coating is uniform when heat is generated from both sides of each sample. Temperatures were taken at approximate center location of the area being heated and results are shown in Table 6. The temperature for Ag@Pt-200 is slightly lower when heated using Method D as compared to Method C.

TABLE 6

| Sample | Method | Temperature (° C.) |
|---|---|---|
| Ag@Pt-200 | C | 119.0 |
| Ag@Pt-200 | D | 114.1 |

### Example 4

This example was carried out in order to test design configurations in which the coatings are supplied with current diagonally across the sample.

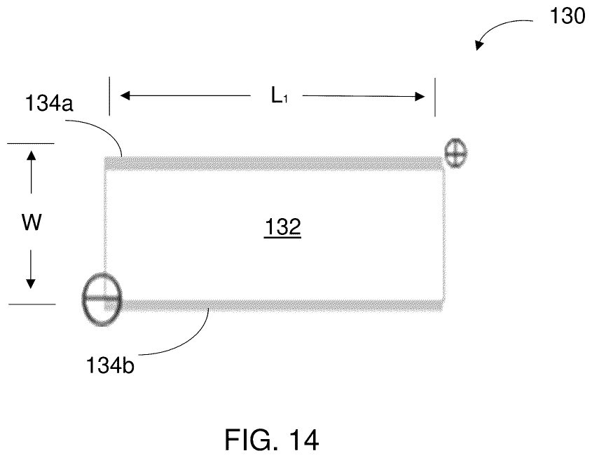

Coated samples Ag@Pt-130 and Ag@Pt-200 were configured for testing using trace design shown in FIG. 14, referred to as Method E. (The withstand voltage of Ag@Pt-100 was less than 40V and therefore was not evaluated.) Trace design 130 shows silver paste traces 134a and 134b defining area 132 of the coated sample. Leads were connected to positive and negative terminals as shown in FIG. 14. Trace design 130 shows silver paste traces 134a and 134b defining area 132 of the coated sample. The width of silver paste traces was 2 mm.

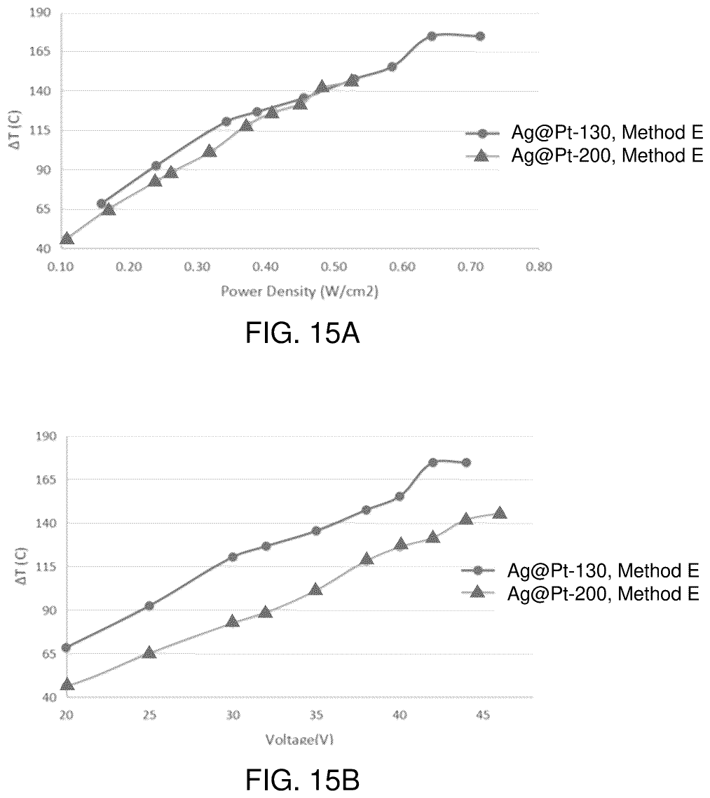

Heating performances of test samples Ag@Pt-130 and Ag@Pt-200 were evaluated by measuring the change in temperature as a function of power density ranging between about 0.1 W/cm² to about 0.8 W/cm². The power density Pa can be calculated as described above for Example 1. A plot showing change in temperature as a function of power density is shown in FIG. 15A. As described above, the voltage was adjusted to achieve the power density. The data suggest Ag@Pt-130 and Ag@Pt-200 exhibit relatively stable performance using Method E. A plot showing change in temperature as a function of voltage is shown in FIG. 15B. As seen in FIG. 15A, the temperature increase depends on the sheet power density, and as seen in FIG. 15B, for a particular voltage a larger temperature increase is observed for the lower sheet resistance heater sample. Circuit resistance for each of the samples was between 50-70 Ohms.

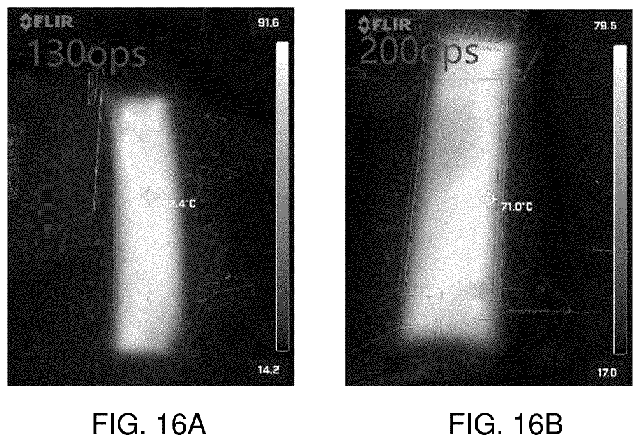

Thermal images of test samples Ag@Pt-130 and Ag@Pt-200 are shown in FIGS. 16A and 16B, respectively. The images suggest heating across the coatings is uniform and stable when heat is generated diagonally. Temperatures were taken at approximate center location of the area being heated and results are shown in Table 7. The temperature for Ag@Pt-200 is lower compared to that of Ag@Pt-130.

TABLE 7

| Sample | Temperature (° C.) |
|---|---|
| Ag@Pt-130 | 92.4 |
| Ag@Pt-200 | 71.0 |

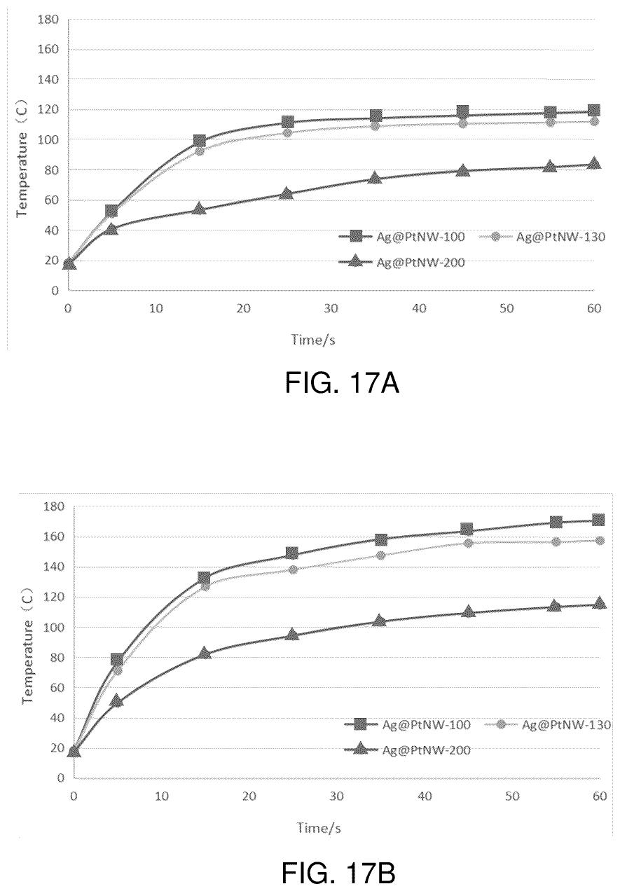

These samples were also used to evaluate the temperature as a function of time. Plots of temperature versus time, at constant voltage of 25V and 35V, are shown in FIGS. 17A and 17B, respectively. The data show similar changes in temperature over time for both voltages, with temperatures higher for samples tested at a constant voltage of 35V as compared to 25V, as expected. Overall, the data suggest gradual rise in temperature reaching a plateau.

### Example 5

This example was carried out in order to explore a design configuration in which coated samples are irregularly shaped as a trapezoid, and the coatings are etched with lines such that resistance distribution of the coatings varies.

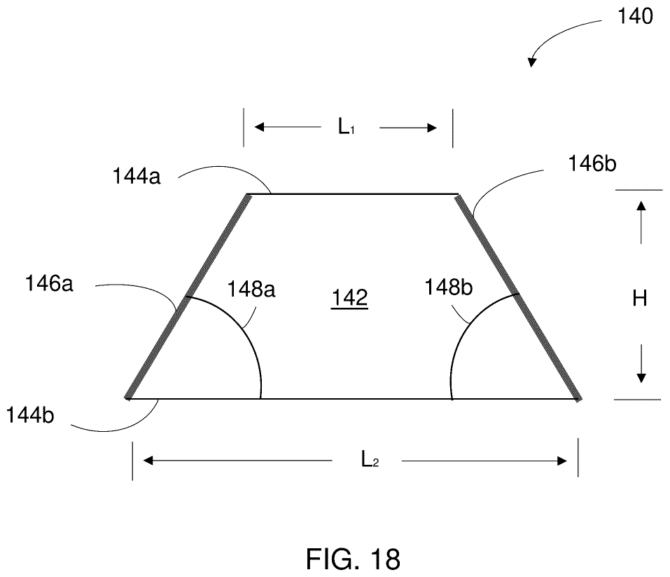

FIG. 18 is a top down view of trapezoid 140 with approximate dimensions to indicate size and shape of the coated samples, which are used in this example. Area 142 is defined by parallel sides 144a and 144b, and sides 146a and 146b which are at about 60° to side 144b as indicated by angles 148a and 148b, respectively. Side 144a has length L₁ which is about 80 mm and side 144b has length L₂ which is about 160 mm. Trapezoid 140 has height H of about 69 mm.

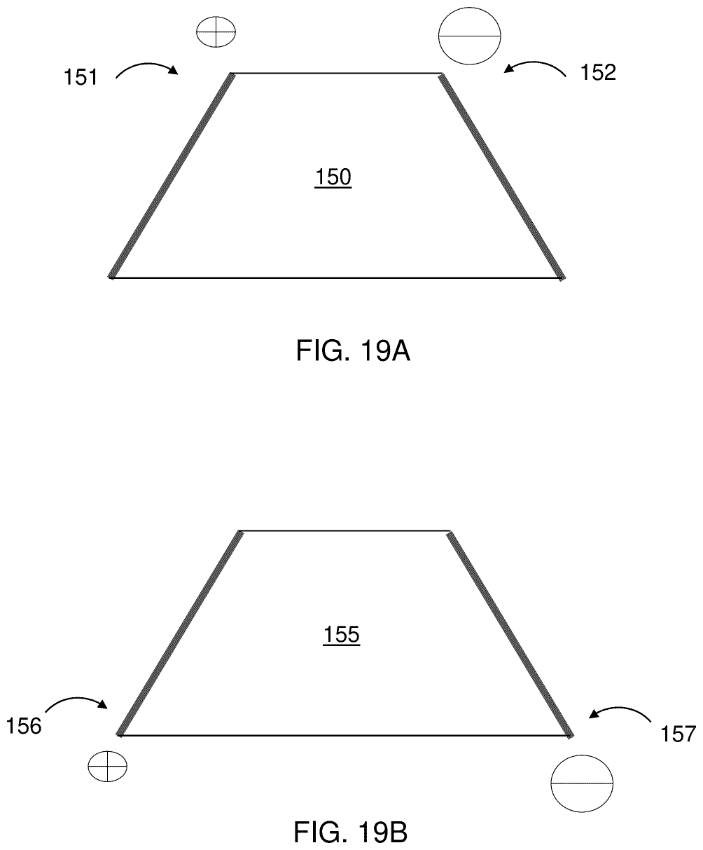

Coated samples of Ag@Pt-130 on substrate PET (Rs˜130 Ohms/sq) were prepared and cut into samples having a trapezoidal shape as shown in FIG. 18. Silver paste traces of about 5 mm were formed on opposing sides 146a and 146b. Leads were connected to define positive and negative terminals on either the short side as shown in FIG. 19A or the long side as shown in FIG. 19B.

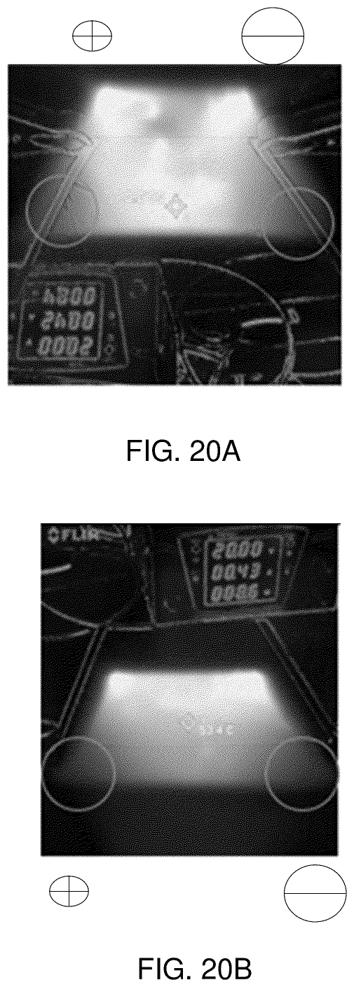

FIGS. 20A and 20B show thermal images of coated samples when configured as shown in FIGS. 19A and 19B, respectively. The images show nonuniform heating for both configurations with opposing corners of the bottom sides having the lowest temperatures. The non-uniformity of the heating is visible.

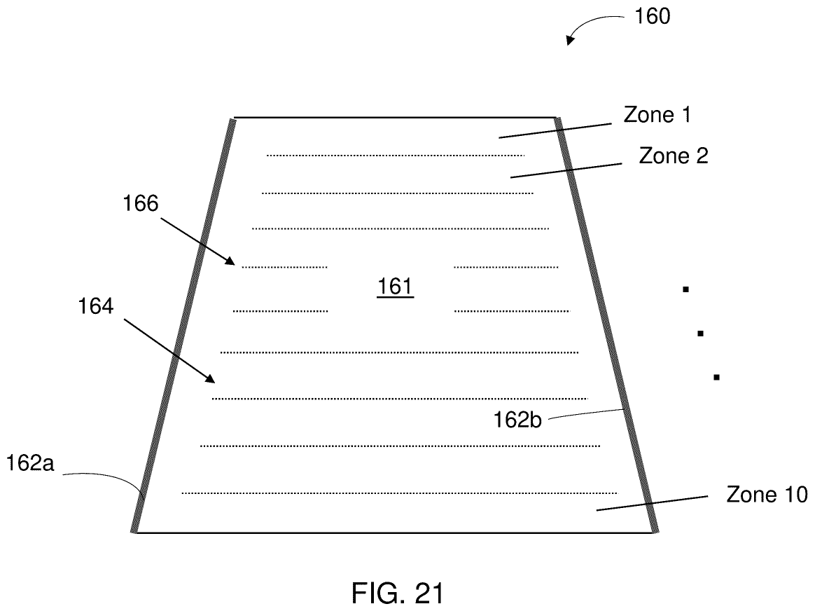

Additional coated samples of Ag@Pt-130 on substrate PET were prepared to test improvements in heating uniformity, and coated substrates were cut into samples having a trapezoidal shape as shown in FIG. 21. Heater 160 includes coated sample 161 with silver paste traces 162a and 162b, each about 5 mm, formed on opposing sides. Zones 1-10 were designated conceptually by dotted lines 166 dividing coated sample 161 into ten zones 164 shown as Zones 1-10. Samples 1 and 2 were prepared, each having Zones 1-10, with each zone being unetched or etched with a different percentage of etched area, as shown in Table 8 (Sample 1) and Table 9 (Sample 2). The number of etched lines is greater for Sample 1 as compared to Sample 2. Laser ablation was used to etch the lines which were about 50 micron thickness. Tables 8 and 9 show the correlation between each zone and the length of the etched lines, percent of etched area and the number of etched lines for Samples 1 and 2, respectively.

TABLE 8

| | Length of | | |
|---|---|---|---|
| | etched lines | Etched | Number of |
| | in each | Area | Etched |
| Zone | Zone(mm) | (%) | Lines |
| 1 | 66 | 50 | 97 |
| 2 | 74 | 46 | 88 |
| 3 | 82 | 42 | 79 |
| 4 | 90 | 37 | 70 |
| 5 | 98 | 32 | 60 |
| 6 | 106 | 26 | 49 |
| 7 | 114 | 21 | 38 |
| 8 | 122 | 14 | 26 |
| 9 | 130 | 7 | 14 |
| 10 | 138 | 0 | 0 |

TABLE 9

| | Length of | | |
|---|---|---|---|
| | etched lines | Etched | Number of |
| | in each Zone | Area | Etched |
| Zone | (mm) | (%) | Lines |
| 1 | 66 | 37 | 72 |
| 2 | 74 | 32 | 61 |
| 3 | 82 | 26 | 50 |
| 4 | 90 | 21 | 39 |
| 5 | 98 | 21 | 39 |
| 6 | 106 | 21 | 38 |
| 7 | 114 | 21 | 38 |
| 8 | 122 | 14 | 26 |
| 9 | 130 | 7 | 14 |
| 10 | 138 | 0 | 0 |

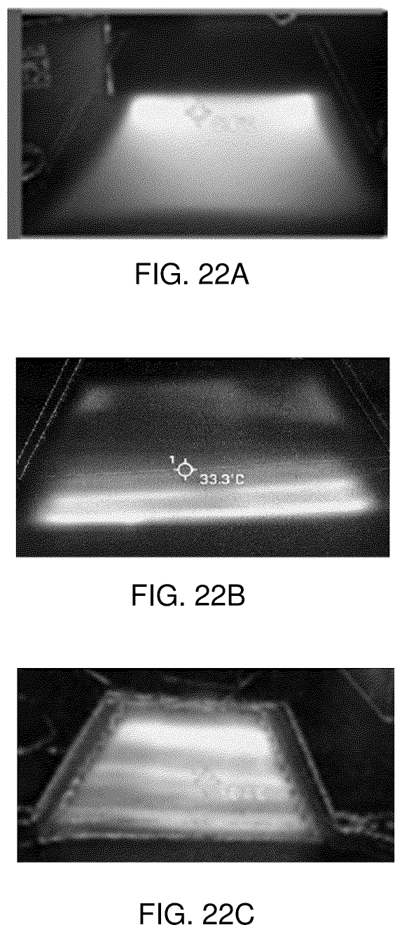

Leads were connected to define positive and negative terminals on the long side as shown as shown in FIG. 19B. The overall resistance (circuit or line resistance) of each heater was measured. Temperature measurements were obtained for each zone by applying a voltage of 24V and reading the temperature after 60 seconds. Results are shown in Table 10. FIGS. 22A, 22B and 22C show thermal images of the coated samples, from top to bottom: unetched, Sample 1 and Sample 2, respectively.

TABLE 10

| Long Edge | Temperature (° C.) | | |
|---|---|---|---|
| Heating | Unetched | Sample 1 | Sample 2 |
| Overall | 39.8 | 120.3 | 84 |
| Resistance | | | |
| (Ohms) | | | |
| 1 | 74.6 | 29.8 | 41.0 |
| 2 | 71.8 | 29.8 | 47.2 |
| 3 | 68.4 | 29.8 | 52.2 |
| 4 | 66.8 | 29.8 | 48.3 |
| 5 | 64.2 | 30.5 | 46.0 |
| 6 | 58.6 | 33.5 | 48.1 |
| 7 | 56.3 | 37.2 | 45.2 |
| 8 | 51.2 | 41.0 | 41.9 |
| 9 | 45.2 | 43.2 | 46.3 |
| 10 | 37.4 | 46.6 | 43.9 |
| Std. Dev. | 12.049 | 6.44 | 3.274 |
| Degree of | 0.313 | 0.239 | 0.121 |
| Dispersion | | | |

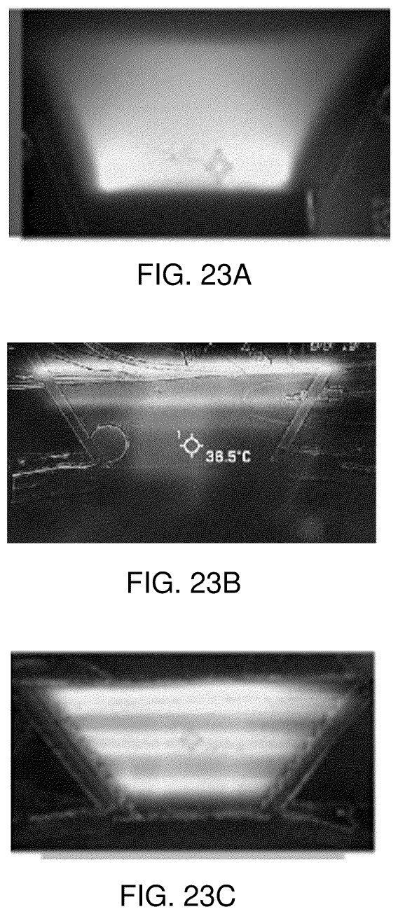

The experiment was repeat except that leads were connected to define positive and negative terminals on the short side as shown as shown in FIG. 19A. Results are shown in Table 11. FIGS. 23A, 23B and 23C show thermal images of the coated samples, from top to bottom: unetched, Sample 1 and Sample 2, respectively. Repeatability from the samples was reasonable, but a careful examination of the samples revealed some imperfections in the laser etching that should be addressable with adjustments of the processing.

TABLE 11

| Short Edge | Temperature (° C.) | | |
|---|---|---|---|
| Heating | Unetched | Sample 1- | Sample 2 - |
| Overall | 39.8 | 120.3 | 84 |
| Resistance | | | |
| (Ohms) | | | |
| 1 | 75.3 | 29.8 | 35.4 |
| 2 | 72.4 | 29.8 | 44.2 |
| 3 | 69.8 | 30.2 | 52.0 |
| 4 | 68.2 | 30.1 | 47.2 |
| 5 | 63.6 | 33.5 | 48.9 |
| 6 | 58.3 | 38.5 | 51.2 |
| 7 | 55.2 | 41.2 | 48.0 |
| 8 | 50.6 | 44.0 | 48.5 |
| 9 | 46.8 | 46.2 | 52.0 |
| 10 | 38.5 | 47.6 | 47.5 |
| Std. Dev. | 12.086 | 7.269 | 4.873 |
| Degree of | 0.307 | 0.240 | 0.174 |
| Dispersion | | | |

### Further Inventive Concepts

A1. A method for heating the surface of a structure, the method comprising delivering a voltage of at least 1 volts to a heating element to generate a surface power density of at least about 0.05 W/cm² for at least about 30 seconds, wherein the heating element comprises a transparent conductive film comprising segments of nanowires in a sparse metal conductive layer and having a sheet resistance from about 0.5 Ohms/sq to about 300 Ohms/sq.

A2. The method of inventive concept A1 wherein the nanowires comprise noble metal coated silver.

A3. The method of inventive concept A1 wherein the transparent structure has an unpatterned area of at least about 0.25 cm².

A4. The method of inventive concept A1 wherein the voltage is delivered by a circuit in electrical contact with the transparent structure and wherein the circuit comprises a segmented electrode with a plurality of segments configured to receive a range of voltages over the plurality of segments for producing a more uniform surface power density.

A5. The method of inventive concept A4 wherein the structure comprises conductive domains isolating the segmented electrode and a counter electrode to have an electrically isolated stripe as a portion of the heater.

A6. The method of inventive concept A1 wherein the voltage is delivered by metal traces that are not arranged to form a grid.

A7. The method of inventive concept A1 wherein the voltage is delivered by electrodes of opposite polarity which are approximately parallel to form a rectangular surface of the transparent conductive element.

A8. The method of inventive concept A1 wherein the voltage is delivered by electrodes of opposite polarity which are at an angle to form a trapezoidal surface of the transparent conductive element.

A9. The method of inventive concept A1 wherein the heating element can generate a sustained surface power density of at least about 0.05 W/cm².

A10. The method of inventive concept A1 wherein the heating element can generate a sustained surface temperature of at least about 220° C.

A11. The method of inventive concept A1 wherein the sparse metal conductive layer comprises a fused metal nanostructured network.

A12. The method of inventive concept A1 wherein the sparse metal conductive layer comprises a plurality of conductive stripes.

A13. The method of inventive concept A1 wherein the structure has a non-rectangular heater surface and the sparse metal conductive layer is etched with no more than about 25% of the layer area removed and/or excluded from a conduction path.

A14. The method of inventive concept A13 wherein the sparse metal conductive layer is etched with a plurality of lines, while maintaining conductive paths between electrodes of opposite polarity and wherein the surface power density is more uniform than with a corresponding unetched transparent heater structure.

A15. The method of inventive concept A13 wherein the sparse metal conductive layer is etched with a plurality of spots and wherein the surface power density is more uniform than with a corresponding unetched transparent heater structure.

A16. The method of inventive concept A1 wherein the structure has a transmittance of at least about 70% over a wavelength range of from about 400 nm to about 750 nm.

A17. The method of inventive concept A1 wherein the structure has a transmittance of at least about 80% over a wavelength range of from about 400 nm to about 750 nm.

A18. The method of inventive concept A1 wherein the structure has a transmittance of at least about 70% over a wavelength range of from about 750 nm to about 1750 nm.

A19. The method of inventive concept A1 wherein the transparent conductive film has a sheet resistance from about 0.5 Ohms/sq to about 250 Ohms/sq.

A20. The method of inventive concept A1 wherein the transparent conductive film is mounted on a transparent polymeric substrate.

A21. The method of inventive concept A1 wherein the transparent conductive film is mounted on glass.

A22. The method of inventive concept A1 wherein the transparent conductive film is mounted between first and second transparent substrates.

B1. A method for making a transparent conductive heater on a surface, the method comprising 1) forming a coating of metal nanowires from a solution, 2) drying the nanowire coating to form a transparent conductive film, and 3) forming conductive electrodes establishing electrical connections to the transparent conductive film with a circuit path along the transparent conductive film between two electrodes forming a heater surface with significant surface power density generated across the heater surface from an applied voltage between the electrodes.

B2. The method of inventive concept B1 wherein the surface is a non-planar transparent surface designed for exposure to an ambient environment, and further comprising applying a protective overcoat over the heater surface.

B3. The method of inventive concept B2 where the protective overcoat is laminated in place with an optically clear adhesive.

B4. The method of inventive concept B2 wherein the protective overcoat is applied as a liquid that is then cured.

B5. The method of inventive concept B1 wherein the surface is on a polymer sheet coated in a roll-to-roll process and further comprising laminating a section of the coated polymer sheet after forming the electrodes to a transparent device surface to be heated.

B6. The method of inventive concept B5 wherein the device surface is a vehicle window.

B7. The method of claim B5 wherein the device surface is a window of an imaging device mounted on a vehicle.

B8. The method of inventive concept B1 wherein the precursor solution further comprises metal ions and wherein the drying forms a fused metal nanostructured network, and wherein the metal nanowires comprise noble metal coated silver nanowires.

B9. The method of inventive concept B1 wherein the electrodes are connected to a power source capable of providing sufficient voltage to generate a surface power density of at least about 0.05 W/cm².

B10. The method of inventive concept B9 wherein the electrodes are configured with opposite polarity electrodes approximately parallel to each other and wherein the sheet resistance of the heater surface is from about 0.5 Ohms/sq to about 250 Ohms/sq.

B11. The method of inventive concept B9 wherein the electrodes are configured with opposite polarity electrodes at an angle to each other to form a trapezoidal shaped heating surface and wherein the resistivity of the transparent conductive film is non-uniform across the heater surface to achieve more uniform surface power density relative to a corresponding heater surface with a uniform resistivity.

B12. The method of inventive concept B11 wherein the non-uniform resistivity is formed by etching the transparent conductive film.

B13. The method of inventive concept B9 wherein the electrodes are divided into segments with the connectors to a power source(s) configured to provide different voltages to different segments of the electrode.

C1. A vehicle comprising a visualization device with a surface exposed to the ambient environment wherein the visualization device transmits and/or receives infrared light over a particular range with wavelengths from 750 nm to 3 microns, a transparent resistive heating element interfaced with the surface of the visualization device, and a control element, wherein the transparent resistive heating element comprises a sparse metal conductive layer comprising nanowire segments having a sheet resistance from about 1 Ohms/sq to about 300 Ohms/sq and having a transmittance of infrared light over the particular range of at least about 70%.

C2. The vehicle of inventive concept C1 wherein the nanowire segments comprise noble metal coated silver.

C3. The vehicle of inventive concept C1 wherein the transparent resistive heating element has a transmittance of visible light of at least about 80%.

C4. The vehicle of inventive concept C1 wherein the transparent resistive heating element is configured to heat a window.

C5. The vehicle of inventive concept C1 wherein the transparent resistive heating element is non-rectangular.

C6. The vehicle of inventive concept C1 wherein the transparent resistive heating element is the heating structure of any one of claims 1-23.

D1. A heater structure having a non-rectangular transparent heater surface and comprising an electrically conductive element, wherein the electrically conductive element is non-uniform in resistance and is between one or more pairs of electrodes such that the power dissipation over the surface of the heater is more uniform relative to the power dissipation in an equivalent structure with a uniform transparent conductive coating.

D2. The heater structure of inventive concept D1 wherein the electrodes are connected to a power source to provide a voltage between respective members of a pair of electrodes.

D3. The heater structure of inventive concept D2 wherein the one or more pairs of electrodes comprise at least two pairs of electrodes with respective members of a pair aligned adjacent corresponding members of the adjacent pair and wherein the pairs of electrodes are connected to power sources that provide different voltages between the respective members of the different pairs.

D4. The heater structure of inventive concept D1 wherein the one or more pairs of electrodes comprise at least two pairs of electrodes with respective members of a pair aligned adjacent corresponding members of the adjacent pair and wherein an in series electrical resistor between the power source and an electrode provides an effective voltage drop between the corresponding electrode pairs.

D5. The heater structure of inventive concept D1 wherein the sparse metal conductive layer is etched.

D6. The heater structure of inventive concept D4 wherein the sparse metal conductive layer is etched at selected spots.

D7. The heater structure of inventive concept D4 wherein the sparse metal conductive layer is etched along lines across the heater surface.

D8. The heater structure of inventive concept D1 wherein the sparse metal conductive layer has different metal loading at different locations along the heater surface.

D9. The heater structure of inventive concept D1 wherein the sparse metal conductive layer comprises a fused metal nanostructured network forming metal nanowire segments wherein the nanowire segments comprise noble metal coated silver.

D10. The heater structure of inventive concept D1 wherein the transparent conductive film has a sheet resistance at any selected point from about 0.5 Ohms/sq to about 250 Ohms/sq.

D11. The conductive structure of inventive concept D9 wherein the electrodes can be connected to a power source to provide a surface power density of at least about 0.05 W/cm².

E1. A heater structure comprising a transparent conductive layer, electrodes connected to a voltage source, and a polymer overcoat over at least a portion of the transparent conductive layer, wherein the transparent conductive coating provides electrical conduction between electrodes to provide heating and wherein the polymer overcoat comprises nanoparticles that provide improved thermal conductivity.

E2. The heater structure of inventive concept E1 wherein the thermally conductive nanoparticles comprise diamond, graphene, silicon nitride, boron nitride, aluminum nitride, gallium arsenide, indium phosphide or a mixture thereof.

E3. The heater structure of inventive concept E1 having one or more of the features of claims 2-23.

F1. A method for making a transparent conductive heater on a non-planer surface, the method comprising: mounting a flexible polymer substrate with a nanowire based transparent conductive heater surface onto a non-planar surface.

F2. The method of inventive concept F1 wherein the sparse metal conductive layer is formed using solution coating of a precursor ink in a roll-to-roll process onto the flexible polymer substrate.

F3. The method of inventive concept F2 wherein the precursor ink comprises metal nanowires and metal ions and wherein drying of the coated precursor solution results in the formation of a fused metal nanostructured network.

F4. The method of inventive concept F2 where the flexible polymer substrate comprises polycarbonate.

F5. The method of inventive concept F2 further comprising printing electrodes at selected locations for heaters structures using silver conductive paste.

F6. The method of inventive concept F2 further comprising forming electrodes at selected locations for heaters structures and further comprising cutting the flexible polymer substrate to obtain a heater structure with a heater surface framed by the electrodes.

F7. The method of inventive concept F6 wherein the heater surface is oriented toward the transparent non-planar surface to form a heated transparent structure.

F8. The method of inventive concept F1 wherein the mounting is performed by lamination with an optically clear adhesive.

F9 The method of inventive concept F1 wherein the mounting is performed by insert molding or over mounding.

F10. The method of inventive concept F1 wherein the device surface is not flat.

F11. The method of inventive concept F1 wherein the heater structure is not rectangular and the electrodes have non-parallel pair of opposite polarity.

F12. The method of inventive concept F11 wherein the sheet resistance is non-uniform across the heater surface to induce more uniform surface power density out from the heater.

F13. The method of inventive concept F11 wherein the electrodes are segmented to form separate electrode pairs of opposite polarity, wherein the transparent conductive layer is etched to form isolated zones corresponding to the electrode segments, and wherein electrode segments are connected to particular voltages to provide more uniform surface power density.

F14, The method of inventive concept F13 wherein the different voltages are provided by using in series resistors.

F15. The method of inventive concept F1 where the flexible polymer substrate comprises polycarbonate.

F16. The method of inventive concept F1 further comprising forming electrodes at selected locations for heaters structures using silver conductive paste.

F17. The method of inventive concept 1 further comprising forming electrodes at selected locations for heaters structures and wherein the heater structure is not rectangular and the electrodes have non-parallel pair of opposite polarity.

F18. The method of inventive concept F17 wherein the sheet resistance is non-uniform across the heater surface to induce more uniform surface power density out from the heater.

F19. The method of inventive concept F17 wherein the electrodes are segmented to form separate electrode pairs of opposite polarity, wherein the transparent conductive layer is etched to form isolated zones corresponding to the electrode segments, and wherein electrode segments are connected to particular voltages to provide more uniform surface power density.

F20. The method of inventive concept F17 wherein the electrodes are segmented to form separate electrode pairs of opposite polarity, wherein the transparent conductive layer is etched to form isolated zones corresponding to the electrode segments, and wherein in series resistors for the separate electrode pairs adjust the current for the resulting heater segments to provide more uniform heat generation.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. A heater structure comprising a substrate, a transparent resistive heating element mounted on the substrate, metal traces forming electrodes arranged to be in electrical contact with the transparent resistive heating element and positioned along boundaries of a heated region defining a circuit for electrical flow through the transparent resistive heating element thereby forming the heated region, and a power source connected to the electrodes wherein the transparent resistive heating element comprises a sparse metal conductive layer comprising nanowire segments and having a sheet resistance from about 0.5 Ohms/sq. to about 300 Ohms/sq.

2. The heater structure of claim 1 wherein the nanowire segments comprise noble metal coated silver.

3. The heater structure of claim 1 having an unpatterned area of at least about 0.25 cm².

4. The heater structure of claim 1 wherein the circuit comprises a segmented electrode with a plurality of segments configured to receive a range of voltages over the plurality of segments for producing a more uniform surface power density.

5. The heater structure of claim 4 wherein the transparent conductive film is etched to form conductive domains isolating the segmented electrode and a counter electrode to have an electrically isolated stripe as a portion of the heater.

6. The heater structure of claim 1 wherein the metal traces do not form a grid.

7. The heater structure of claim 1 wherein the electrodes of opposite polarity are approximately parallel to form a rectangular heating surface.

8. The heater structure of claim 1 wherein the electrodes of opposite polarity are at an angle to form a trapezoidal heater surface.

9. The heater structure of claim 1 wherein the power source can deliver at least about 1 volt to the electrodes and wherein the transparent resistive heating element can generate a sustained surface power density of at least about 0.05 W/cm².

10. The heater structure of claim 1 wherein the transparent resistive heater element can generate a sustained surface temperature of at least about 220° C.

11. The heater structure of claim 1 wherein the sparse metal conductive layer comprises a fused metal nanostructured network.

12. The heater structure of claim 1 wherein the sparse metal conductive layer comprises a plurality of conductive stripes.

13. The heater structure of claim 1 having a non-rectangular heater surface and an etched transparent conductive layer with no more than about 25% of the transparent conductive layer area removed and/or excluded from the conduction path.

14. The heater structure of claim 13 wherein the sparse metal conductive layer is etched with a plurality of lines, while maintaining conductive paths between electrodes of opposite polarity and wherein the surface power density is more uniform than with a corresponding unetched transparent heater structure.

15. The heater structure of claim 13 wherein the sparse metal conductive layer is etched with a plurality of spots and wherein the surface power density is more uniform than with a corresponding unetched transparent heater structure.

16. The heater structure of claim 1 wherein the transparent heater structure has a transmittance of at least about 70% over a wavelength range of from about 400 nm to about 750 nm.

17. The heater structure of claim 1 wherein the transparent heater structure has a transmittance of at least about 80% over a wavelength range of from about 400 nm to about 750 nm.

18. The heater structure of claim 1 wherein the transparent heater structure has a transmittance of at least about 70% over a wavelength range of from about 750 nm to about 1750 nm.

19. The heater structure of claim 1 wherein the sparse metal conductive layer has a sheet resistance from about 0.5 Ohms/sq to about 250 Ohms/sq.

20. The heater structure of claim 1 wherein the substrate comprises a transparent polymeric substrate.

21. The heater structure of claim 1 wherein the substrate comprises glass.

22. The heater structure of claim 1 wherein the substrate comprises a first transparent substrate and the transparent heater structure further comprises a second transparent substrate mounted on the transparent resistive heating element opposite the first transparent substrate.

23. The heater structure of claim 1 wherein the structure is bendable and flexible.

24. A window for a vehicle comprising the heater structure of claim 1.

25. An infrared based imaging system comprising the heater structure of claim 1.
